(19) United States
(12) Patent Application Publication
(10) Pub. No.: US 2025/0317240 A1
(43) Pub. Date: Oct. 9, 2025

(54) BLOCK RETRANSMISSION REPETITIONS

(71) Applicant: QUALCOMM Incorporated, San Diego, CA (US)

(72) Inventors: Joel LINSKY, San Diego, CA (US); Mayank BATRA, Cambridge (GB)

(21) Appl. No.: 18/896,611

(22) Filed: Sep. 25, 2024

Related U.S. Application Data
(60) Provisional application No. 63/631,009, filed on Apr. 8, 2024.

(51) Int. Cl. H04L 1/08

(52) U.S. Cl. CPC H04L 1/08

(57) ABSTRACT

To improve the probability of receiving a link layer block, a block retransmission repetition scheme may be utilized. Block retransmission repetition may enable link layer blocks to be included more than once in a retransmission, thereby increasing the probability that the retransmitted link layer block can be successfully received. In some approaches, a quantity of retransmissions of a link layer block may be determined without explicitly signaling the quantity of retransmissions. For instance, a wireless device may determine the quantity of retransmissions based on a quantity of negative acknowledgments and a limit on link layer blocks associated with the payload. Determining the quantity of retransmissions without explicitly signaling the quantity may avoid consuming bits in a packet header for explicitly indicating the quantity, thereby reducing complexity or reducing the time taken over the air for the additional bits in the packet header.

### CROSS REFERENCE

The present Application for Patent claims the benefit of U.S. Provisional Patent Application No. 63/631,009 by LINSKY et al., entitled “BLOCK RETRANSMISSION REPETITIONS,” filed Apr. 8, 2024, assigned to the assignee hereof, and expressly incorporated by reference herein.

### TECHNICAL FIELD

This disclosure relates to wireless communication and, more specifically, to block retransmission repetitions.

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a wireless local area network (WLAN), such as a Wi-Fi (Institute of Electrical and Electronics Engineers (IEEE) 802.11) network may include an access point (AP) that may communicate with one or more wireless or mobile devices. The AP may be coupled to a network, such as the Internet, and may enable a mobile device to communicate via the network (or communicate with other devices coupled to the AP). A wireless device may communicate with a network device bi-directionally. For example, in a WLAN, a device may communicate with an associated AP via downlink (such as the communication link from the AP to the device) and uplink (such as the communication link from the device to the AP). A wireless personal area network (WPAN), which may include a Bluetooth connection, may provide for short range wireless connections between two or more paired wireless devices. For example, wireless devices such as cellular phones may utilize WPAN communications to exchange information such as audio signals with wireless headsets.

In some examples, Bluetooth communications may require enhanced quality of service. For example, successful bidirectional transmission of audio information for voice may have a relatively low tolerance for packet loss or timing issues. The link quality between two devices may affect the data rate used for communications (such as poor link quality may be associated with reduced bitrates for more robust communications).

### SUMMARY

The systems, methods, and devices of this disclosure each have several innovative aspects, no single one of which is solely responsible for the desirable attributes disclosed herein.

A method for wireless communication by a first wireless device is described. The method may include transmitting a payload to a second wireless device, where the payload is segmented into a set of multiple link layer blocks, each link layer block of the set of multiple link layer blocks including a respective portion of the payload, receiving, from the second wireless device, one or more negative acknowledgments associated with the set of multiple link layer blocks, and transmitting, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

A first wireless device for wireless communication is described. The first wireless device may include a processing system that includes processor circuitry and memory circuitry that stores code. The processing system may be configured to cause the first wireless device to transmit a payload to a second wireless device, where the payload is segmented into a set of multiple link layer blocks, each link layer block of the set of multiple link layer blocks including a respective portion of the payload, receive, from the second wireless device, one or more negative acknowledgments associated with the set of multiple link layer blocks, and transmit, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

Another first wireless device for wireless communication is described. The first wireless device may include means for transmitting a payload to a second wireless device, where the payload is segmented into a set of multiple link layer blocks, each link layer block of the set of multiple link layer blocks including a respective portion of the payload, means for receiving, from the second wireless device, one or more negative acknowledgments associated with the set of multiple link layer blocks, and means for transmitting, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

A non-transitory computer-readable medium storing code for wireless communication is described. The code may include instructions executable by one or more processors to transmit a payload to a second wireless device, where the payload is segmented into a set of multiple link layer blocks, each link layer block of the set of multiple link layer blocks including a respective portion of the payload, receive, from the second wireless device, one or more negative acknowledgments associated with the set of multiple link layer blocks, and transmit, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

Some examples of the method, first wireless devices, and non-transitory computer-readable medium described herein may further include operations, features, means, or instructions for receiving an indication of a capability of the second wireless device to receive link layer block repetitions, where transmitting the quantity of repetitions may be based on receiving the indication of the capability.

In some examples of the method, first wireless devices, and non-transitory computer-readable medium described herein, the quantity of repetitions may be based on a limitation for a total quantity of repetitions of the at least one link layer block.

In some examples of the method, first wireless devices, and non-transitory computer-readable medium described herein, the quantity of repetitions may be based on a minimum of the limitation for the total quantity of repetitions or a floor value of a ratio of the limit of link layer blocks and the quantity of the one or more negative acknowledgments.

In some examples of the method, first wireless devices, and non-transitory computer-readable medium described herein, transmitting the quantity of repetitions may include operations, features, means, or instructions for transmitting a last block of the quantity of repetitions based on the quantity of repetitions, the quantity of the one or more negative acknowledgments, and the limit of link layer blocks.

In some examples of the method, first wireless devices, and non-transitory computer-readable medium described herein, transmitting the last block may include operations, features, means, or instructions for refraining from transmitting a link layer block that would exceed the limit of link layer blocks associated with the payload.

In some examples of the method, first wireless devices, and non-transitory computer-readable medium described herein, the last block may be the quantity of repetitions minus one in a case that the quantity of the one or more negative acknowledgments times the quantity of repetitions may be equal to the limit of link layer blocks.

Some examples of the method, first wireless devices, and non-transitory computer-readable medium described herein may further include operations, features, means, or instructions for transmitting the quantity of repetitions may be based on a first priority of a first link layer block of the set of multiple link layer blocks relative to a second priority of a second link layer block of the set of multiple link layer blocks.

In some examples of the method, first wireless devices, and non-transitory computer-readable medium described herein, a first quantity of repetitions for the first link layer block may be greater than a second quantity of repetitions for the second link layer block.

A method for wireless communication by a second wireless device is described. The method may include receiving a payload from a first wireless device, where the payload is segmented into a set of multiple link layer blocks, each link layer block of the set of multiple link layer blocks including a respective portion of the payload, transmitting, to the first wireless device, one or more negative acknowledgments associated with the set of multiple link layer blocks, and receiving, from the first wireless device, a quantity of repetitions of at least one link layer block associated with the one or more negative acknowledgments, where the quantity of repetitions is based on a quantity of the one or more negative acknowledgments and a limit of link layer blocks associated with the payload.

A second wireless device for wireless communication is described. The second wireless device may include a processing system that includes processor circuitry and memory circuitry that stores code. The processing system may be configured to cause the second wireless device to receive a payload from a first wireless device, where the payload is segmented into a set of multiple link layer blocks, each link layer block of the set of multiple link layer blocks including a respective portion of the payload, transmit, to the first wireless device, one or more negative acknowledgments associated with the set of multiple link layer blocks, and receive, from the first wireless device, a quantity of repetitions of at least one link layer block associated with the one or more negative acknowledgments, where the quantity of repetitions is based on a quantity of the one or more negative acknowledgments and a limit of link layer blocks associated with the payload.

Another second wireless device for wireless communication is described. The second wireless device may include means for receiving a payload from a first wireless device, where the payload is segmented into a set of multiple link layer blocks, each link layer block of the set of multiple link layer blocks including a respective portion of the payload, means for transmitting, to the first wireless device, one or more negative acknowledgments associated with the set of multiple link layer blocks, and means for receiving, from the first wireless device, a quantity of repetitions of at least one link layer block associated with the one or more negative acknowledgments, where the quantity of repetitions is based on a quantity of the one or more negative acknowledgments and a limit of link layer blocks associated with the payload.

A non-transitory computer-readable medium storing code for wireless communication is described. The code may include instructions executable by one or more processors to receive a payload from a first wireless device, where the payload is segmented into a set of multiple link layer blocks, each link layer block of the set of multiple link layer blocks including a respective portion of the payload, transmit, to the first wireless device, one or more negative acknowledgments associated with the set of multiple link layer blocks, and receive, from the first wireless device, a quantity of repetitions of at least one link layer block associated with the one or more negative acknowledgments, where the quantity of repetitions is based on a quantity of the one or more negative acknowledgments and a limit of link layer blocks associated with the payload.

Some examples of the method, second wireless devices, and non-transitory computer-readable medium described herein may further include operations, features, means, or instructions for transmitting an indication of a capability of the second wireless device to receive link layer block repetitions, where receiving the quantity of repetitions may be based on transmitting the indication of the capability.

In some examples of the method, second wireless devices, and non-transitory computer-readable medium described herein, the quantity of repetitions may be based on a limitation for a total quantity of repetitions of the at least one link layer block.

In some examples of the method, second wireless devices, and non-transitory computer-readable medium described herein, the quantity of repetitions may be based on a minimum of the limitation for the total quantity of repetitions or a floor value of a ratio of the limit of link layer blocks and the quantity of the one or more negative acknowledgments.

In some examples of the method, second wireless devices, and non-transitory computer-readable medium described herein, receiving the quantity of repetitions may include operations, features, means, or instructions for receiving a last block of the quantity of repetitions based on the quantity of repetitions, the quantity of the one or more negative acknowledgments, and the limit of link layer blocks.

In some examples of the method, second wireless devices, and non-transitory computer-readable medium described herein, receiving the last block may include operations, features, means, or instructions for refraining from receiving a link layer block that would exceed the limit of link layer blocks associated with the payload.

In some examples of the method, second wireless devices, and non-transitory computer-readable medium described herein, the last block may be the quantity of repetitions minus one in a case that the quantity of the one or more negative acknowledgments times the quantity of repetitions may be equal to the limit of link layer blocks.

Some examples of the method, second wireless devices, and non-transitory computer-readable medium described herein may further include operations, features, means, or instructions for receiving the quantity of repetitions may be based on a first priority of a first link layer block of the set of multiple link layer blocks relative to a second priority of a second link layer block of the set of multiple link layer blocks.

In some examples of the method, second wireless devices, and non-transitory computer-readable medium described herein, a first quantity of repetitions for the first link layer block may be greater than a second quantity of repetitions for the second link layer block.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that supports.

FIG. 2 shows an example of a wireless communications system that supports block retransmission repetitions.

FIG. 3 shows an example of frame structures that support block retransmission repetitions.

FIG. 4 shows an example of a process flow that supports block retransmission repetitions.

FIGS. 5 and 6 show block diagrams of devices that support block retransmission repetitions.

FIG. 7 shows a block diagram of an I/O controller that supports block retransmission repetitions.

FIG. 8 shows a diagram of a system including a device that supports block retransmission repetitions.

FIGS. 9 and 10 show block diagrams of devices that support block retransmission repetitions.

FIG. 11 shows a block diagram of an I/O controller that supports block retransmission repetitions.

FIG. 12 shows a diagram of a system including a device that supports block retransmission repetitions.

FIGS. 13 through 16 show flowcharts illustrating methods that support block retransmission repetitions.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Some wireless communications systems may utilize redundancy to increase the probability of a successful transmission. Since bit errors may occur at any point in a packet, adding redundancy to the packet may improve the probability that transmitted data is received correctly. Redundancy may be implemented using various techniques, such as modulation techniques, convolutional or repetition codes, or other mechanisms.

In some approaches, a payload may be segmented to improve the overall efficiency of the system. In payload segmentation, an overall payload may be divided into smaller segments, where each segment (such as a block) may be protected with a cyclic redundancy check (CRC) code. In some examples, each segment may be referred to as a link layer block. System efficiency may be gained by enabling the retransmission of one or more link layer blocks that had errors, as opposed to retransmitting the entire payload.

In some approaches, each link layer block may be retransmitted exactly once per packet. While retransmitting a link layer block once per packet may improve the probability of reception of that link layer block (due to the overall time or length of the packet being shorter and less likely to be interfered with, for instance), limiting a link layer block to a single retransmission may lack redundancy.

In some approaches, a quantity of repetitions per packet may be explicitly signaled. Explicitly signaling the quantity of repetitions may consume communication resources, or may be limited to indicating the same quantity of repetitions for each link layer block per packet. For instance, some approaches to block repetition may rely on explicit signaling in the packet.

To improve the probability of receiving a link layer block, a block retransmission repetition scheme may be utilized. Block retransmission repetition may enable link layer blocks to be included more than once in a retransmission, thereby increasing the probability that the retransmitted link layer block can be successfully received. In some approaches, a quantity of retransmissions of a link layer block may be determined without explicitly signaling the quantity of retransmissions. For instance, a wireless device may determine the quantity of retransmissions based on a quantity of negative acknowledgments and a limit on link layer blocks associated with the payload.

Particular aspects of the subject matter described in this disclosure can be implemented to realize one or more of the following potential advantages. Determining the quantity of retransmissions without explicitly signaling the quantity may avoid consuming bits in a packet header for explicitly indicating the quantity, thereby reducing complexity or reducing the time taken over the air for the additional bits in the packet header. Additionally, or alternatively, some of the techniques described herein may be utilized to enable flexibility to change the determination approach (such as an algorithm for determining the quantity of retransmission repetitions) based on content without redesigning the packet header.

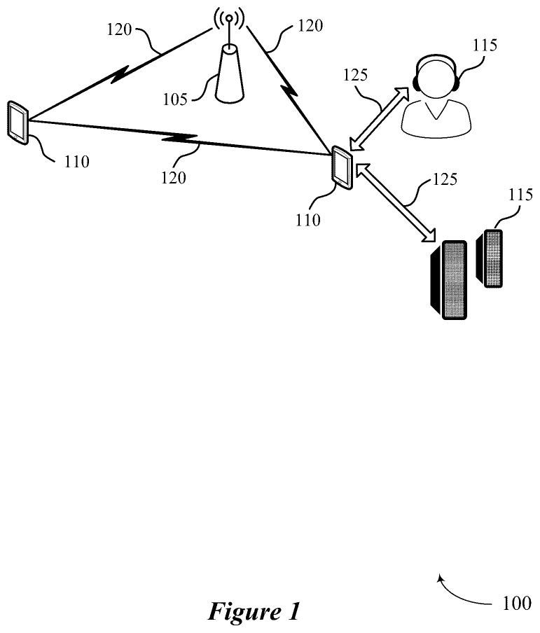

FIG. 1 shows an example of a wireless communications system 100 that supports techniques for dynamically adjusting retransmission opportunities within a CIS in accordance with aspects of the present disclosure. In some examples, the wireless communications system 100 may include or refer to a wireless personal area network (PAN), a wireless local area network (WLAN, a Wi-Fi network) configured in accordance with various aspects of the present disclosure. The wireless communications system 100 may include an access point (AP) 105, device(s) 110 (which may be referred to as source devices or central devices, among other examples), or paired device(s) 115 (which may be referred to as sink devices or peripheral devices, among other examples) implementing WLAN communications (such as Wi-Fi communications) and/or Bluetooth communications. For example, devices 110 may include cell phones, user equipment (UEs), wireless stations (STAs), mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (such as devices 110), which may include wireless audio devices (such as headsets, earbuds, speakers, ear pieces, or headphones), display devices (such as TVs, computer monitors), microphones, meters, or valves, among other examples.

Bluetooth communications may refer to a short-range communication protocol and may be used to connect and exchange information between devices 110 and paired devices 115 (such as between mobile phones, computers, digital cameras, wireless headsets, speakers, keyboards, mice or other input peripherals, and similar devices). Bluetooth systems (such as aspects of wireless communications system 100) may be organized using a central-peripheral relationship employing a time-division duplex protocol having, for example, defined time slots of 625 microseconds, in which transmission alternates between the central device (such as a device 110) and one or more peripheral devices (such as paired devices 115). In some examples, a device 110 may generally refer to a central device, and a paired device 115 may refer to a peripheral device in the wireless communications system 100. As such, in some examples, a device may be referred to as either a device 110 or a paired device 115 based on the Bluetooth role configuration of the device. That is, designation of a device as either a device 110 or a paired device 115 may not necessarily indicate a distinction in device capability, but rather may refer to or indicate roles held by the device in the wireless communications system 100. Generally, device 110 may refer to a wireless communication device capable of wirelessly exchanging data signals with another device (such as a paired device 115), and paired device 115 may refer to a device operating in a peripheral role, or to a short-range wireless communication device capable of exchanging data signals with the device 110 (such as using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack. For example, a Bluetooth specification may include various profiles that define the behavior associated with each communication endpoint to implement a specific use. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs (such as roles for a device 110 and a paired device 115) that together form a profile (such as for communications between the device 110 and the paired device 115). One example profile defined in the Bluetooth specification is the Handsfree Profile (HFP) for voice telephony, in which one device (such as a device 110) implements an Audio Gateway (AG) role and the other device (such as a paired device 115) implements a Handsfree (HF) device role. Another example is the Advanced Audio Distribution Profile (A2DP) for high-quality audio streaming, in which one device (such as device 110) implements an audio source device (SRC) role and another device (such as paired device 115) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (such as a cell phone) may have to be present within radio range. Likewise, in order to stream high-quality mono or stereo audio according to the A2DP, a device implementing the SNK role (such as Bluetooth headphones or Bluetooth speakers) may have to be within radio range of a device implementing the SRC role (such as a stereo music player).

The Bluetooth specification defines a layered data transport architecture and various protocols and procedures to handle data communicated between two devices that implement a particular profile. For example, various logical links are available to support different application data transport requirements, with each logical link associated with a logical transport having certain characteristics (such as flow control, acknowledgment mechanisms, repeat mechanisms, sequence numbering, or scheduling behavior, among other examples). The Bluetooth protocol stack may be split in two parts: a controller stack including the timing critical radio interface, and a host stack handling high level data. The controller stack may be generally implemented in a low cost silicon device including a Bluetooth radio and a microprocessor. The controller stack may be responsible for setting up connection links 125 such as asynchronous connection-oriented links, (or asynchronous connection-oriented connections), synchronous connection-orientated (SCO) links (or SCO connections), extended synchronous connection-oriented (eSCO) links (or eSCO connections), or other logical transport channel links, among other examples.

In some examples, the controller stack may implement link management protocol (LMP) functions, or low energy link layer (LE LL) functions, among other examples. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, or service discovery protocol (SDP) functions, among other examples. In some examples, the controller stack and the host stack may communicate via a host controller interface (HCI). In other implementations, (such as for integrated devices such as Bluetooth headsets), the host stack and controller stack may be run on the same microprocessor to reduce mass production costs. For such host-less systems, the HCI may be optional, and may be implemented as an internal software interface.

A connection link 125 may be established between two Bluetooth-enabled devices (such as between a device 110 and a paired device 115, between two devices 110, or between two paired devices 115, among other examples) and may provide for communications or services (such as according to some Bluetooth profile). For example, a Bluetooth connection may be an eSCO connection for voice call (such as which may allow for retransmission) or an ACL connection for music streaming (such as A2DP), among other examples. For instance, eSCO packets may be transmitted in predetermined time slots (such as 6 Bluetooth slots each for eSCO). The regular interval between the eSCO packets may be specified when the Bluetooth link is established. The eSCO packets to/from a specific device (such as paired device 115) are acknowledged, and may be retransmitted if not acknowledged during a retransmission window. In addition, audio may be streamed between a device 110 and a paired device 115 using an ACL connection (A2DP profile). In some examples, the ACL connection may occupy 1, 3, or 5 Bluetooth slots for data or voice. Other Bluetooth profiles supported by Bluetooth-enabled devices may include Bluetooth Low Energy (BLE) (such as providing considerably reduced power consumption and cost while maintaining a similar communication range), human interface device profile (HID) (such as providing low latency links with low power requirements), or Bluetooth High Data Throughput (HDT), among other examples.

A device may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 110 may support WLAN communications via AP 105 (such as over communication links 120). The AP 105 and the associated devices 110 may represent a basic service set (BSS) or an extended service set (ESS). The various devices 110 in the network may be able to communicate with one another through the AP 105. In some examples, the AP 105 may be associated with a coverage area, which may represent a basic service area (BSA).

Devices 110 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, or 802.11ax, among other examples. In some other implementations, peer-to-peer connections or ad hoc networks may be implemented within the wireless communications system 100, and devices may communicate with each other via communication links 120 (such as Wi-Fi Direct connections, Wi-Fi Tunneled Direct Link Setup (TDLS) links, peer-to-peer communication links, other peer or group connections). AP 105 may be coupled to a network, such as the Internet, and may enable a device 110 to communicate via the network (or communicate with other devices 110 coupled to the AP 105). A device 110 may communicate with a network device bi-directionally. For example, in a WLAN, a device 110 may communicate with an associated AP 105 via downlink (such as the communication link from the AP 105 to the device 110) and uplink (such as the communication link from the device 110 to the AP 105).

In some examples, content, media, audio, or other information exchanged between a device 110 and a paired device 115 may originate from a WLAN. For example, in some examples, device 110 may receive audio from an AP 105 (such as via WLAN communications), and the device 110 may relay or pass the audio to the paired device 115 (such as via Bluetooth communications). In some examples, certain types of Bluetooth communications (such as such as high quality or high definition (HD) Bluetooth) may require enhanced quality of service. For example, in some examples, delay-sensitive Bluetooth traffic may have higher priority than WLAN traffic.

One or more wireless devices (such as device(s) 110 or paired device(s) 115) may utilize block retransmission repetition to enable link layer blocks to be included more than once in a retransmission. In some approaches, a quantity of retransmissions of a link layer block may be determined without explicitly signaling the quantity of retransmissions. For instance, a wireless device (such as a device 110 or paired device 115) may determine the quantity of retransmissions based on a quantity of negative acknowledgments and a limit on link layer blocks associated with the payload.

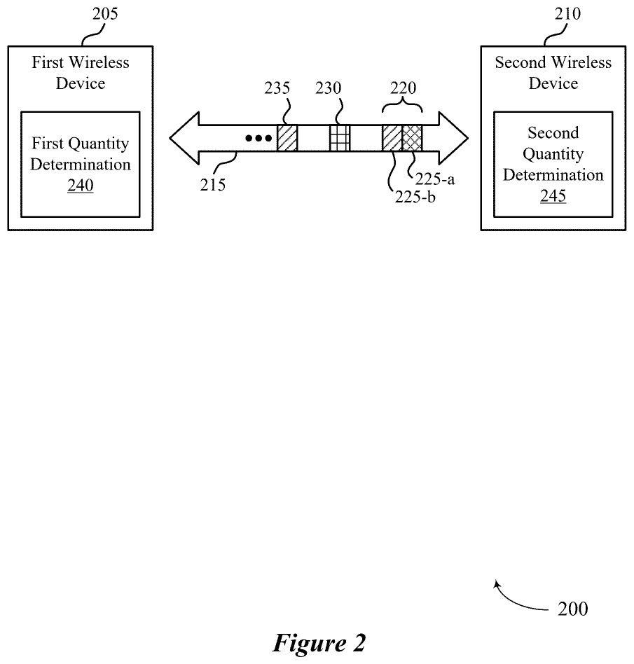

FIG. 2 shows an example of a wireless communications system 200 that supports block retransmission repetitions. The wireless communications system 200 may implement or may be implemented to realize one or more aspects of the wireless communications system 100. With reference to FIG. 1, the first wireless device 205 or the second wireless device 210 may be examples of the device 110 or the paired device 115. For example, the first wireless device 205 and the second wireless device 210 may be examples of devices 110 or paired devices 115, or a device 110 and a paired device 115, as illustrated by and described with reference to FIG. 1.

In some aspects, one of the first wireless device 205 or the second wireless device 210 may be a central device, an initiator, a source device, or a first host and initiating layer and the other of the first wireless device 205 and the second wireless device 210 may be a peripheral device, an acceptor, a sink device, or a second host and responding layer. In some implementations, the first wireless device 205 or the second wireless device 210, or both, may support a configuration for retransmission repetition as described herein.

In some examples, the first wireless device 205 or the second wireless device 210 may support one or more aspects of Bluetooth specifications. For instance, the first wireless device 205 or the second wireless device 210 may support one or more aspects of Bluetooth classic, BLE, or Bluetooth HDT specifications.

The first wireless device 205 and the second wireless device 210 may establish a communication link 215. The communication link 215 may be an example of the connection link 125 described with reference to FIG. 1. In some approaches, the first wireless device 205 or the second wireless device 210 may perform one or more discovery procedures or paging procedures to establish a link. For instance, the first wireless device 205 or the second wireless device 210 may transmit one or more inquiry signals for discovery or may perform paging to establish the communication link 215.

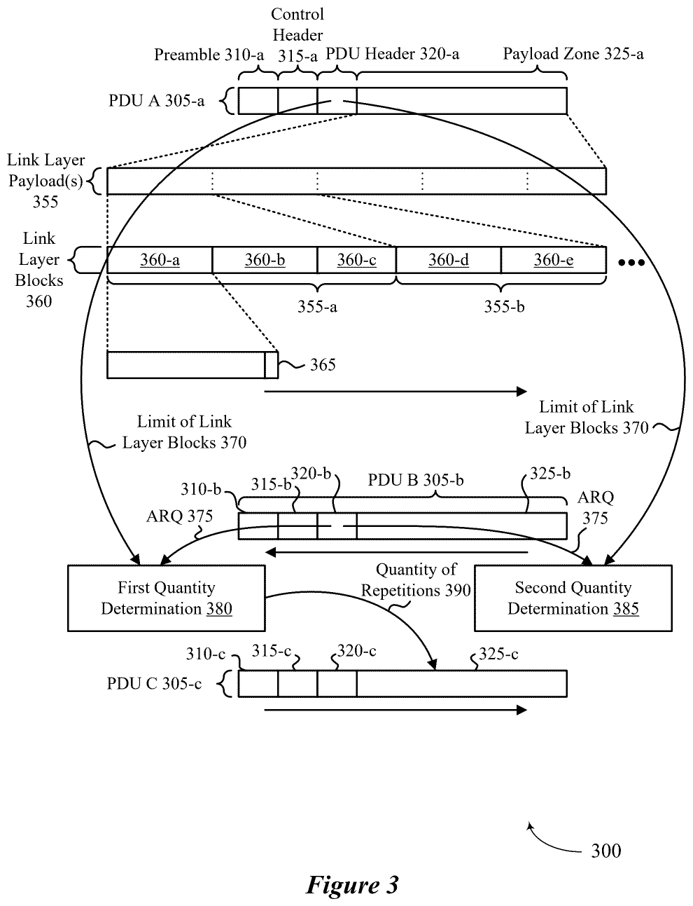

The first wireless device 205 may transmit, or the second wireless device 210 may receive, a payload 220. The payload 220 may indicate data, such as audio data, text data, video data, or other data. The payload 220 may be segmented into multiple link layer blocks. For example, the payload 220 may be segmented into a first link layer block 225-a and a second link layer block 225-b. While the example of FIG. 2 illustrates two link layer blocks, a different quantity of link layer blocks may be utilized in some implementations. Each link layer block of the plurality of link layer blocks may include a respective portion of the payload 220. In some examples, the payload 220 may be included in a protocol data unit (PDU). For instance, a PDU may include a preamble, a control header, a PDU header, or the payload 220 (in a payload zone, for instance). An example of a payload segmented into link layer blocks in a PDU is given with reference to FIG. 3.

In some examples, the second wireless device 210 may fail to successfully receive one or more of the plurality of link layer blocks. For instance, the first link layer block 225-a and the second link layer block 225-b may each have a CRC code attached. The second wireless device 210 may utilize the CRC (such as a checksum) to determine whether each of the plurality of link layer blocks is received successfully or unsuccessfully. For instance, if a polynomial division of a link layer block does not match the attached CRC code, the second wireless device 210 may detect a failure to successfully receive the link layer block.

The second wireless device 210 may transmit, or the first wireless device 205 may receive, one or more negative acknowledgments 230 associated with the plurality of link layer blocks (such as the first link layer block 225-a or the second link layer block 225-b). For instance, the second wireless device 210 may generate a negative acknowledgment for each link layer block that was not received successfully. In some approaches, a negative acknowledgment may be expressed as a “NACK” or an automatic repeat request (ARQ) value (such as ARQ=0). In some aspects, the one or more negative acknowledgments 230 may be included in a bitmask, where each bit of the bitmask indicates whether a corresponding link layer block was successfully received (such as ARQ=1) or was not successfully received (such as ARQ=0). Each negative acknowledgment may indicate a command or request for the first wireless device 205 to retransmit the link layer block that was not successfully received (such as that was unsuccessfully received).

The first wireless device 205 may transmit, or the second wireless device 210 may receive, a quantity of repetitions 235 of at least one link layer block associated with the one or more negative acknowledgments 230. In a scenario where a negative acknowledgment 230 is transmitted associated with the first link layer block 225-a, for example, the first wireless device 205 may retransmit one or more repetitions 235 of the first link layer block 225-a.

In some examples, the first wireless device 205 may include a first quantity determination component 240, or the second wireless device 210 may include a second quantity determination component 245. The first quantity determination component 240 or the second quantity determination component 245 may be implemented in hardware (such as circuitry) or a combination of hardware and instructions (such as one or more processors with instructions or executable code). In some approaches, the first quantity determination component 240 or the second quantity determination component 245 may be utilized to determine the quantity of the repetitions 235 (such as retransmission repetitions). For instance, the first quantity determination component 240 or the second quantity determination component 245 may be utilized to determine the quantity of the repetitions 235 without explicitly signaling the quantity. Determining the quantity of repetitions 235 without explicitly signaling the quantity may reduce or avoid some overhead signaling or may provide increased flexibility to provide different quantities of repetitions for different link layer blocks. The first quantity determination component 240 or the second quantity determination component 245 may determine the quantity based on one or more factors (such as a quantity of the one or more negative acknowledgments 230, a limit of link layer blocks, or a limitation for a total quantity of link layer blocks). In some examples, the first quantity determination component 240 or the second quantity determination component 245 may perform one or more of the techniques described herein relating to the quantity of the repetitions 235. In some aspects, a “repetition” may refer to one or more repetitions of a previously transmitted link layer block.

In some approaches, the quantity (such as “ReTxper_Block”) of repetitions 235 may be associated with a quantity or number (such as “Blocksto_ReTx”) of the one or more negative acknowledgments 230 or a limit (such as “BlocksPayload_Max”) of link layer blocks associated with the payload 220. The quantity of the one or more negative acknowledgments 230 may indicate a quantity or number of link layer blocks for retransmission. For instance, the quantity of the one or more negative acknowledgments (such as Blocksto_ReTx) may be a quantity of blocks for retransmission. The quantity of the one or more negative acknowledgments 230 may be the total quantity or number of negative acknowledgments associated with the plurality of link layer blocks (such as associated with a PDU or associated with the first link layer block 225-a and the second link layer block 225-b, among other examples). For instance, the first wireless device 205 or the second wireless device 210 may sum the one or more negative acknowledgments 230 to determine the quantity of the one or more negative acknowledgments.

The limit of link layer blocks may be a quantity or number of link layer blocks (such as “NB,” BlocksPayload_Max, or a quantity of link layer blocks that can be transmitted in a PDU, among other examples). For instance, the limit of link layer blocks may be a maximum quantity or number of blocks for a current payload (such as the payload 220 or a payload of a PDU for retransmission(s)). In some approaches, the quantity of link layer blocks may be indicated in a PDU communicated (such as transmitted or received) between the first wireless device 205 and the second wireless device 210. For instance, the limit of link layer blocks may be communicated in a PDU header. In some examples, the limit of link layer blocks may indicate the quantity of link layer blocks in the payload 220 (such as a PDU) or a quantity of link layer blocks available in a PDU for retransmission. Examples of the limit 370 of link layer blocks indicated in a PDU header are provided with reference to FIG. 3.

In some examples, the quantity of repetitions 235 may be determined in accordance with Equation (1).

$${ReTx}_{per \_ Block} = ⌊ \frac{{Blocks}_{Payload \_ Max}}{{Blocks}_{to \_ ReTx}} ⌋ \qquad ( 1 )$$

In Equation (1), ReTx_{per_Block} is the quantity of repetitions 235 (such as a quantity of times to repeat each block in a retransmission), Blocks_{to_ReTx} is the quantity of the one or more negative acknowledgments 230, Blocks_{Payload_Max} is a limit of link layer blocks associated with the payload 220, and └x┘ denotes the floor function (which may provide a greatest integer that is less than or equal to x). In this example, the quantity of repetitions 235 is a floor value of a ratio of the limit of link layer blocks to the quantity of the one or more negative acknowledgments.

In some examples, the quantity of repetitions 235 may be associated with a limitation (such as “Repetition_{Max}”) for a total quantity of repetitions 235 of the at least one link layer block. The limitation for a total quantity of repetitions 235 may be a configured limitation of (such as a maximum) quantity of times that a link layer block may be retransmitted. For instance, the quantity of repetitions 235 may be selected between the

$$⌊ \frac{{Blocks}_{Payload \_ Max}}{{Blocks}_{to \_ ReTx}} ⌋$$

and the Repetition_{Max}. In some approaches,

$$⌊ \frac{{Blocks}_{Payload \_ Max}}{{Blocks}_{to \_ ReTx}} ⌋$$

may be selected if it is less than or equal to Repetition_{Max}. Otherwise, Repetition_{Max} may be selected.

In some aspects, the quantity of repetitions 235 may be associated with a minimum of the limitation for the total quantity of repetitions 235 or a floor value of a ratio of the limit of link layer blocks and the quantity of the one or more negative acknowledgments 230. A total quantity of repetitions 235 may be bounded by Blocks_{Payload_Max}, Blocks_{to_ReTx}, and Repetition_{Max}. For instance, the quantity of repetitions 235 may be determined in accordance with Equation (2).

$${ReTx}_{per \_ Block} = MIN ( ⌊ \frac{{Blocks}_{Payload \_ Max}}{{Blocks}_{to \_ ReTx}} ⌋ , {Repetition}_{Max} ) \qquad ( 2 )$$

In some examples, selecting between

$$⌊ \frac{{Blocks}_{Payload \_ Max}}{{Blocks}_{to \_ ReTx}} ⌋$$

and Repetition_{Max} (such as selecting a minimum) may tailor the amount of resources used for retransmission based on the quantity of blocks indicated for retransmission while capping the quantity of resources used to the limitation.

In some scenarios where multiple link layer blocks are retransmitted, the same quantity or a different quantity of repetitions may be utilized for different link layer blocks. For instance, three repetitions may be communicated for the first link layer block 225-a and two repetitions may be communication for the second link layer block 225-b.

In some approaches, transmitting or receiving the quantity of repetitions 235 may be associated with a first priority of the first link layer block 225-a of the plurality of link layer blocks relative to a second priority of the second link layer block 225-b of the plurality of link layer blocks. For example, the first link layer block 225-a may carry data (such as a reference frame for compressed video, parameters for linear predictive coding (LPC) for audio signals, emergency services data, among other examples) with a relatively higher priority than the second link layer block 225-b. In some examples, a first quantity of repetitions for the first link layer block 225-a may be greater than a second quantity of repetitions for the second link layer block. For instance, a limitation (such as “Repetition_{Max}”) for a total quantity of repetitions for the first quantity of repetitions for the first link layer block 225-a may be greater than a total quantity of repetitions for the second quantity of repetitions for the second link layer block 225-b. In some approaches, the priorities of the respective link layer blocks may be determined based on the content (such as frame types, data type, among other examples) of the respective link layer blocks, may be indicated (such as signaled), or may be preconfigured. Allowing differing quantities of repetitions for different priorities may enable providing greater redundancy or reliability to one or more link layer blocks with relatively higher priority, reducing resource usage for one or more link layer blocks with relatively lower priority, or balancing resource usage to favor one or more link layer blocks with relatively higher priority.

In some examples, transmitting or receiving the quantity of repetitions 235 may include transmitting or receiving a last block (such as “ReTx_{last_Block}”) of the quantity of repetitions 235 based on the quantity (such as ReTx_{per_Block}) of repetitions 235, the quantity (such as Blocks_{to_ReTx}) of the one or more negative acknowledgments 230, or the limit of link layer blocks (such as Blocks_{Payload_Max}) for the total quantity of repetitions 235. In some examples, the last block (such as ReTx_{last_Block}) may be the quantity of repetitions 235 in a scenario that the quantity of the one or more negative acknowledgments 230 is 1 (such as ReTx_{per_Block} if Blocks_{to_ReTx}=1). In some examples, the last block (such as ReTx_{last_Block}) may be the quantity of repetitions 235 minus one in a scenario that the quantity of the one or more negative acknowledgments 230 times the quantity of repetitions 235 is equal to the limit of link layer blocks (such as ReTx_{per_Block}−1 if Blocks_{to_ReTx}×ReTx_{per_Block}=Blocks_{Payload_Max}). For instance, the first wireless device 205 may refrain from transmitting, or the second wireless device 210 may refrain from receiving, a link layer block that would exceed the limit of link layer blocks associated with the payload 220. In some examples, the last block (such as ReTx_{last_Block}) may be the quantity of repetitions 235 in a scenario that the quantity of the one or more negative acknowledgments 230 times the quantity of repetitions 235 is less than the limit of link layer blocks (such as

$${ReTx}_{per \_ Block} if {Blocks}_{to \_ ReTx} \times {ReTx}_{per \_ Block} < {Blocks}_{Payload \_ Max} ) .$$

In some examples, the last block (such as “ReTx_{last_Block}”) may be determined in accordance with one or more aspects of Equation (3).

$$( 3 )$$

$${ReTx}_{last \_ Block} = \{ \begin{matrix}{ReTx}_{per \_ Block} & if {Blocks}_{to \_ ReTx} = 1 \\ {ReTx}_{per \_ Block} - 1 & if {Blocks}_{to \_ ReTx} \times {ReTx}_{per \_ Block} = {Blocks}_{Payload \_ Max} \\ {ReTx}_{per \_ Block} & if {Blocks}_{to \_ ReTx} \times {ReTx}_{per \_ Block} < {Blocks}_{Payload \_ Max}\end{matrix}$$

In some examples, the last block may have a reduced quantity of retransmissions because it may be unlikely that each block in the payload will have identical length. In some approaches, a fixed block length may be used, where the length of all blocks except the last block may have the same size, and the last block may include the remainder of the bytes in the payload. During retransmissions, the total length of the payload may not increase. Determining the last block may avoid changing the length of the payload.

Table (1) provides some examples of the determination of the quantity (ReTx_{per_Block}) of repetitions based on Blocks_{Payload_Max}, Blocks_{to_ReTx}, and Repetition_{Max}>7.

TABLE 1

| Blocks_{Payload}_{_{—}}_{Max} | Blocksₜₒ_{_{—}}_{ReTx} | ReTxₚₑᵣ_{_{—}}_{Block} |
|---|---|---|
| 8 | 1 | 7 |
| 8 | 2 | 4 (Relxₗₐₛₜ_{_{—}}_{Block} = 3) |
| 8 | 3 | 2 |
| 8 | 4 | 2 (Relxₗₐₛₜ_{_{—}}_{Block} = 1) |
| 8 | 5 | 1 |
| 8 | 6 | 1 |
| 8 | 7 | 1 |
| 8 | 8 | 1 |

Table (2) provides some examples of the determination of the quantity (ReTx_{per_Block}) of repetitions based on Blocks_{Payload_Max}, Blocks_{to_ReTx}, and Repetition_{Max}=4.

TABLE 2

| Blocks_{Payload}_{_{—}}_{Max} | Blocksₜₒ_{_{—}}_{ReTx} | ReTxₚₑᵣ_{_{—}}_{Block} |
|---|---|---|
| 8 | 1 | 4 |
| 8 | 2 | 4 (Relxₗₐₛₜ_{_{—}}_{Block} = 3) |
| 8 | 3 | 2 |
| 8 | 4 | 2 (ReTxₗₐₛₜ_{_{—}}_{Block} = 1) |
| 8 | 5 | 1 |
| 8 | 6 | 1 |
| 8 | 7 | 1 |
| 8 | 8 | 1 |

As illustrated by the examples of Table (2), Repetition_{Max} may cap the quantity of repetitions allowed.

In some examples, the first wireless device 205 or the second wireless device 210 may signal an indication of a capability to communicate (such as to transmit or receive) link layer block repetitions. For instance, the second wireless device 210 may transmit, or the first wireless device 205 may receive, an indication of a capability of the second wireless device 210 to receive link layer block repetitions, where transmitting the quantity of repetitions 235 may be based on receiving the indication of the capability. Additionally, or alternatively, the first wireless device 205 may transmit, or the second wireless device 210 may receive, an indication of a capability of the first wireless device 205 to transmit link layer block repetitions, where transmitting the quantity of repetitions 235 may be based on transmitting the indication of the capability. In some examples, the indication of the capability may be signaled in a payload (or not in a PDU header). In some approaches, the indication of the capability may be signaled during link 215 setup or negotiation. In some aspects, block retransmission repetition may be enabled when both sides of the link (such as the transmitter and the receiver) support the feature. In some aspects, the use of block retransmission repetition may be negotiated using a protocol (such as a link layer configuration protocol) or may be pre-configured using a non-volatile memory (NVM) setting.

FIG. 3 shows an example of frame structures 300 that support block retransmission repetitions. For example, one or more PDUs may be communicated (such as transmitted or received) based on one or more of the frame structures 300. The example of FIG. 3 illustrates PDU A 305-a, a PDU B 305-b, and a PDU C 305-c. In some aspects, PDU A 305-a may be transmitted from a first wireless device (such as the first wireless device 205) to a second wireless device (such as the second wireless device 210), PDU B 305-b may be transmitted from the second wireless device to the first wireless device, or PDU C 305-c may be transmitted from the first wireless device to the second wireless device. FIG. 3 also illustrates a first quantity determination component 380 and a second quantity determination component 385. The first quantity determination component 380 may be an example of the first quantity determination component 240 and the second quantity determination component 385 may be an example of the second quantity determination component 245 described with reference to FIG. 2. While an example of frame structures 300 is described, some of the techniques described herein may be implemented with another frame structure. For instance, one or more of the techniques described herein may be implemented with a frame structure in accordance with Bluetooth Classic, BLE, or Bluetooth HDT.

PDU A 305-a includes a preamble 310-a, a control header 315-a, a PDU header 320-a, and a payload zone 325-a. PDU B 305-b includes a preamble 310-b, a control header 315-b, a PDU header 320-b, and a payload zone 325-b. PDU C 305-c includes a preamble 310-c, a control header 315-c, a PDU header 320-c, and a payload zone 325-c. In some examples, one or more of the characteristics described for one or more of the elements of PDU A 305-a may similarly correspond to one or more of the elements of PDU B 305-b or PDU C 305-c. In some examples, one or more of PDU A 305-a, PDU B 305-b, or PDU C 305-c may include one or more additional or alternative elements (such as a clear channel assessment (CCA) field, constant tone extension (CTE), message integrity check (MIC) field, among other examples). In some examples of the techniques described herein, one or more aspects of link layer block repetition may be performed for a PDU with a packet format indicator (PFI) (such as PFI=1), or may not be performed for another PDU with another PFI (such as PFI=0).

The preamble 310-a may include one or more short training sequences (STSs), a guard interval (GI), or one or more long training sequences (LTSs). The preamble 310-a may be utilized for automatic gain control (AGC), frequency estimation, bias (such as direct current (DC)) removal, packet detection, or carrier frequency offset (CFO) estimation (for equalization), among other examples. In some aspects, the preamble 310-a may occupy approximately 37 microseconds (μs).

The control header 315-a may indicate information (such as 64 bits of information). For instance, the control header 315-a may identify a connection, identify a modulation and rate for PDU A 305-a (after the control header 315-a), provide an acknowledgment of a payload (such as of a whole payload), indicate a PFI, indicate a length, or indicate a physical layer (PHY) interval size for PDU A 305-a, among other examples. In some aspects, the control header 315-a may occupy approximately 32 μs.

In some examples, when the PFI=1, the payload zone 325-a may include one or more link layer packets, where the link layer packets may be segmented. Segmentation of a link layer packet into link layer blocks may allow selective retransmission for one or more of the link layer blocks.

The PDU header 320-a may have a variable length or may include varying information, which may be based on the PFI, a quantity of bits in the PDU header 320-a, or a connection type. In some examples, the PDU header 320-a may include an indication of a limit 370 of link layer blocks (such as a quantity of link layer blocks, NB, or Blocks_{Payload_Max}, among other examples). For instance, the PDU header 320-a may include a transmit (Tx) portion that may include one or more length indications and one or more descriptors (corresponding to one or more respective payloads for the payload zone 325-a, for instance), where a descriptor may indicate the limit 370 of link layer blocks.

In some aspects, the payload zone 325-a may include one or more link layer payloads 355. For instance, the payload zone 325-a may include one or more PHY intervals (not shown in FIG. 3), which may include the one or more link layer payloads 355. The PHY interval(s) may be independent of the link layer payloads (such as there may not be a one-to-one relationship between the PHY intervals and the link layer payload(s) 355 or link layer blocks 360).

As described herein, each of the link layer payload(s) 355 may be segmented into link layer blocks 360. For instance, a first link layer payload 355-a may be segmented into link layer blocks 360-a, 360-b, and 360-c. A second link layer payload 355-b may be segmented into link layer block 360-d and 360-e. In some examples, each of the link layer blocks 360 may include a CRC field. For instance, a first link layer block 360-a includes a CRC field 365.

When PDU A 305-a is transmitted to a second wireless device, the second wireless device may utilize the CRC field of each of the link layer blocks 360 to detect whether each of the link layer blocks 360 is received successfully or unsuccessfully. For instance, if a polynomial division of the data included in the first link layer block 360-a does not match the CRC of the CRC field 365, the second wireless device may detect that the first link layer block 360-a has not been successfully received. The second wireless device may determine an automatic repeat request (ARQ) 375. For instance, the ARQ 375 may be a bitmask that indicates whether each of the link layer blocks 360 was received successfully or not. The ARQ 375 may include one or more negative acknowledgments respectively corresponding to one or more unsuccessfully received link layer blocks. The second wireless device may transmit PDU B 305-b that includes the ARQ 375 to the first wireless device.

The first quantity determination component 380 or the second quantity determination component 385 may utilize the limit 370 of link layer blocks (such as Blocks_{Payload_Max}) and the ARQ 375 (such as Blocks_{to_ReTx}, which may be a sum of the negative acknowledgments of the ARQ 375) to determine a quantity of repetitions 390 (such as ReTx_{per_Block}). For instance, the first quantity determination component 380 or the second quantity determination component 385 may determine the quantity of repetitions 390 as described with reference to FIG. 2. In some examples, the first quantity determination component 380 or the second quantity determination component 385 also may utilize a limitation (such as Repetition_{Max}) for a total quantity of repetitions to determine the quantity of repetitions 390 as described with reference to FIG. 2. In some examples, a same quantity of repetitions 390 may apply to each unsuccessfully received link layer block, or a separate (such as different) quantity of repetitions 390 may apply for each respective unsuccessfully received link layer block.

The first wireless device may transmit PDU C 305-c, which may include the quantity of repetitions 390 for the one or more unsuccessfully received link layer blocks. For instance, the first wireless device may construct the payload zone 325-c based on the quantity of repetitions 390. The second wireless device may utilize a quantity of repetitions (similarly determined to the quantity of repetitions 390, for example) to receive PDU C 305-c. For instance, the second wireless device may utilize the quantity of repetitions to determine which portions of the payload zone 325-c correspond to which of the one or more unsuccessfully received link layer blocks (for de-mapping or decoding, for instance).

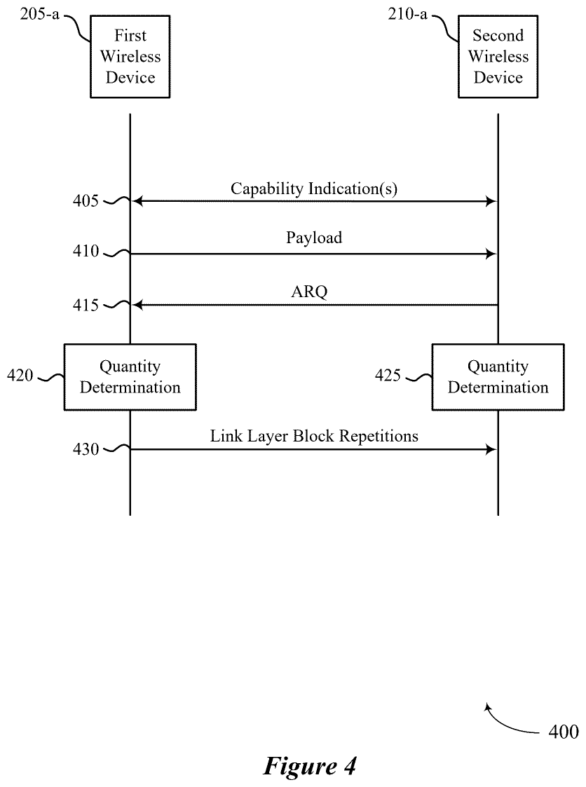

FIG. 4 shows an example of a process flow 400 that supports block retransmission repetitions. The process flow 400 may implement or be implemented to realize or facilitate aspects of the wireless communications system 100, the wireless communications system 200, or the frame structures 300. For example, the process flow 400 illustrates communication between a first wireless device 205-a and a second wireless device 210-a. The first wireless device 205-a may be an example of the first wireless device 205 described with reference to FIG. 2. The second wireless device 210-a may be an example of the second wireless device 210 described with reference to FIG. 2. Additionally, or alternatively, the first wireless device 205-a or the second wireless device 210 may be examples of the device 110 or the paired device 115 described with reference to FIG. 1.

In the following description of the process flow 400, the operations may be performed (such as reported or provided) in a different order than the order shown, or the operations performed by the example devices may be performed in different orders or at different times. For example, specific operations also may be left out of the process flow 400, or other operations may be added to the process flow 400. Further, although some operations or signaling may be shown to occur at different times for discussion purposes, these operations may actually occur concurrently or in overlapping time frames.

At 405, the first wireless device 205-a or the second wireless device 210-a may communicate one or more capability indications. For instance, one or more of the first wireless device 205-a or the second wireless device 210-a may transmit or receive a capability indication indicating a capability of the first wireless device 205-a or the second wireless device 210-a to transmit or receive link layer block retransmission repetition as described with reference to one or more of FIG. 2 or FIG. 3.

At 410, the first wireless device 205-a may transmit a payload to the second wireless device 210-a. For instance, the first wireless device 205-a may transmit a payload that includes one or more link layer blocks as described with reference to one or more of FIG. 2 or FIG. 3.

At 415, the second wireless device 210-a may transmit an ARQ to the first wireless device 205-a. For instance, the second wireless device 210-a may transmit one or more negative acknowledgments associated with one or more link layer blocks as described with reference to one or more of FIG. 2 or FIG. 3.

At 420, the first wireless device 205-a may perform a quantity determination for a quantity of repetitions of one or more of the link layer blocks. For instance, the first wireless device 205-a may determine the quantity of repetitions as described with reference to one or more of FIG. 2 or FIG. 3.

At 425, the second wireless device 210-a may perform a quantity determination for a quantity of repetitions of one or more of the link layer blocks. For instance, the second wireless device 210-a may determine the quantity of repetitions as described with reference to one or more of FIG. 2 or FIG. 3.

At 430, the first wireless device 205-a may transmit one or more link layer block repetitions to the second wireless device 210-a. For instance, the first wireless device 205-a may transmit one or more repetitions of the one or more link layer blocks as described with reference to one or more of FIG. 2 or FIG. 3.

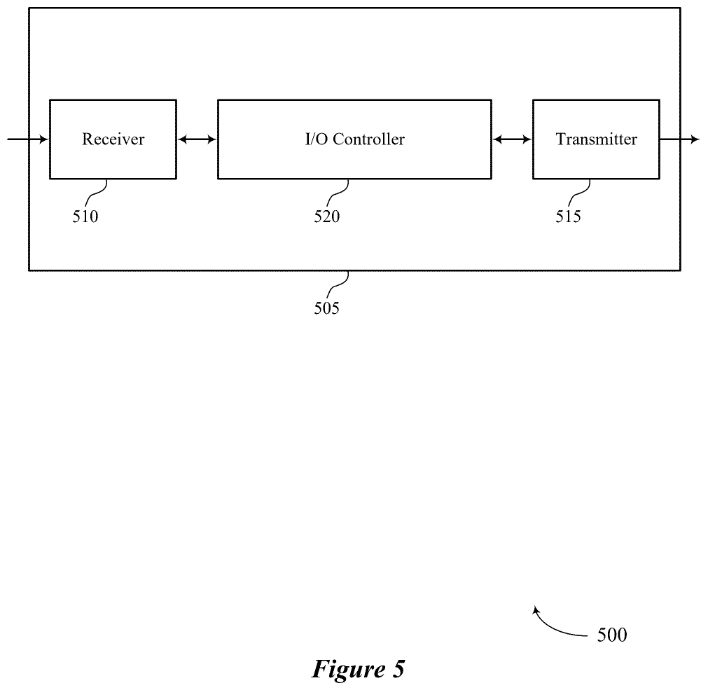

FIG. 5 shows a block diagram 500 of a device 505 that supports block retransmission repetitions. The device 505 may be an example of aspects of a first wireless device (such as a first wireless device 205 or a first wireless device 205-a) as described herein. The device 505 may include a receiver 510, a transmitter 515, and an I/O controller 520. The device 505, or one or more components of the device 505 (such as the receiver 510, the transmitter 515, the I/O controller 520), may include at least one processor, which may be coupled with at least one memory, to, individually or collectively, support or enable the described techniques. Each of these components may be in communication with one another (such as via one or more buses).

The receiver 510 may provide a means for receiving information such as packets, user data, control information, or any combination thereof associated with various information channels (such as control channels, data channels, information channels related to block retransmission repetitions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (such as control channels, data channels, information channels related to block retransmission repetitions). In some examples, the transmitter 515 may be co-located with a receiver 510 in a transceiver module. The transmitter 515 may utilize a single antenna or a set of multiple antennas.

The I/O controller 520, the receiver 510, the transmitter 515, or various combinations or components thereof may be examples of means for performing various aspects of block retransmission repetitions as described herein. For example, the I/O controller 520, the receiver 510, the transmitter 515, or various combinations or components thereof may be capable of performing one or more of the functions described herein.

In some examples, the I/O controller 520, the receiver 510, the transmitter 515, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the I/O controller 520, the receiver 510, the transmitter 515, or various combinations or components thereof may be implemented in code (such as communications management software or firmware) executed by at least one processor (such as referred to as a processor-executable code). If implemented in code executed by at least one processor, the functions of the I/O controller 520, the receiver 510, the transmitter 515, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the I/O controller 520 may be configured to perform various operations (such as receiving, obtaining, monitoring, outputting, transmitting) using or otherwise in cooperation with the receiver 510, the transmitter 515, or both. For example, the I/O controller 520 may receive information from the receiver 510, send information to the transmitter 515, or be integrated in combination with the receiver 510, the transmitter 515, or both to obtain information, output information, or perform various other operations as described herein.

The I/O controller 520 may support wireless communication in accordance with examples as disclosed herein. For example, the I/O controller 520 is capable of, configured to, or operable to support a means for transmitting a payload to a second wireless device, where the payload is segmented into a set of multiple link layer blocks, each link layer block of the set of multiple link layer blocks including a respective portion of the payload. The I/O controller 520 is capable of, configured to, or operable to support a means for receiving, from the second wireless device, one or more negative acknowledgments associated with the set of multiple link layer blocks. The I/O controller 520 is capable of, configured to, or operable to support a means for transmitting, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

By including or configuring the I/O controller 520 in accordance with examples as described herein, the device 505 (such as at least one processor controlling or otherwise coupled with the receiver 510, the transmitter 515, the I/O controller 520, or a combination thereof) may support techniques for reduced processing, reduced power consumption, or more efficient utilization of communication resources.

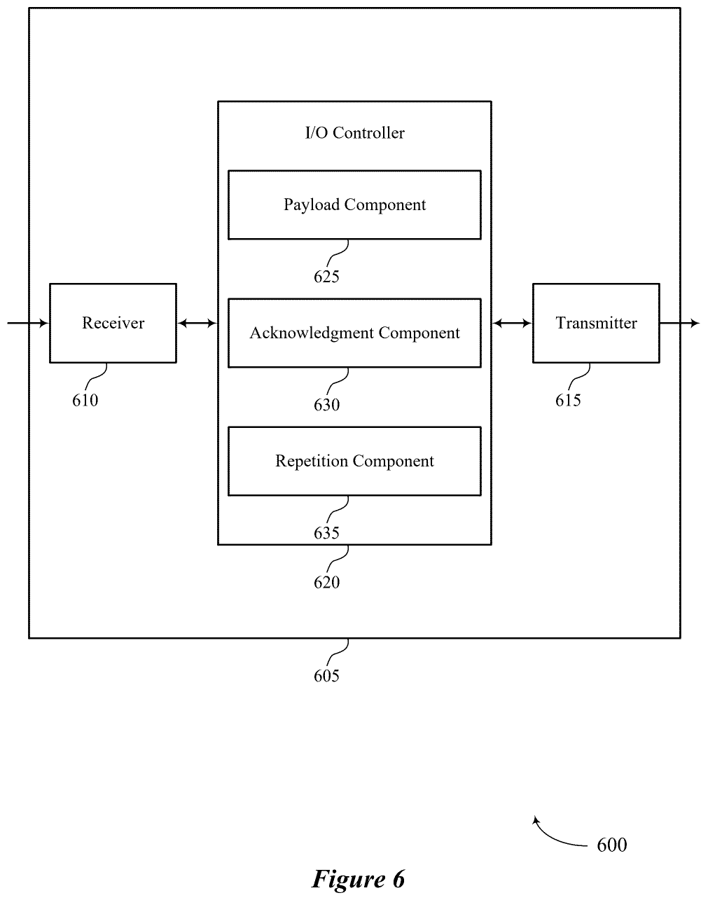

FIG. 6 shows a block diagram 600 of a device 605 that supports block retransmission repetitions. The device 605 may be an example of aspects of a device 505 or a first wireless device (such as a first wireless device 205 or a first wireless device 205-a) as described herein. The device 605 may include a receiver 610, a transmitter 615, and an I/O controller 620. The device 605, or one or more components of the device 605 (such as the receiver 610, the transmitter 615, the I/O controller 620), may include at least one processor, which may be coupled with at least one memory, to support the described techniques. Each of these components may be in communication with one another (such as via one or more buses).

The receiver 610 may provide a means for receiving information such as packets, user data, control information, or any combination thereof associated with various information channels (such as control channels, data channels, information channels related to block retransmission repetitions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (such as control channels, data channels, information channels related to block retransmission repetitions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of block retransmission repetitions as described herein. For example, the I/O controller 620 may include a payload component 625, an acknowledgment component 630, a repetition component 635, or any combination thereof. The I/O controller 620 may be an example of aspects of a I/O controller 520 as described herein. In some examples, the I/O controller 620, or various components thereof, may be configured to perform various operations (such as receiving, obtaining, monitoring, outputting, transmitting) using or otherwise in cooperation with the receiver 610, the transmitter 615, or both. For example, the I/O controller 620 may receive information from the receiver 610, send information to the transmitter 615, or be integrated in combination with the receiver 610, the transmitter 615, or both to obtain information, output information, or perform various other operations as described herein.

The I/O controller 620 may support wireless communication in accordance with examples as disclosed herein. The payload component 625 is capable of, configured to, or operable to support a means for transmitting a payload to a second wireless device, where the payload is segmented into a set of multiple link layer blocks, each link layer block of the set of multiple link layer blocks including a respective portion of the payload. The acknowledgment component 630 is capable of, configured to, or operable to support a means for receiving, from the second wireless device, one or more negative acknowledgments associated with the set of multiple link layer blocks. The repetition component 635 is capable of, configured to, or operable to support a means for transmitting, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

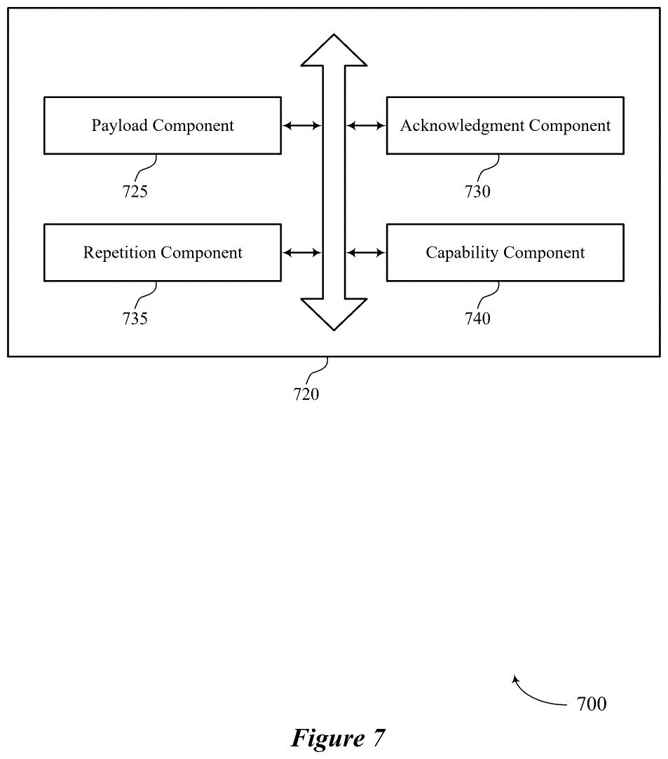

FIG. 7 shows a block diagram 700 of an I/O controller 720 that supports block retransmission repetitions. The I/O controller 720 may be an example of aspects of an I/O controller 520, an I/O controller 620, or both, as described herein. The I/O controller 720, or various components thereof, may be an example of means for performing various aspects of block retransmission repetitions as described herein. For example, the I/O controller 720 may include a payload component 725, an acknowledgment component 730, a repetition component 735, a capability component 740, or any combination thereof. Each of these components, or components or subcomponents thereof (such as one or more processors, one or more memories), may communicate, directly or indirectly, with one another (such as via one or more buses).

The I/O controller 720 may support wireless communication in accordance with examples as disclosed herein. The payload component 725 is capable of, configured to, or operable to support a means for transmitting a payload to a second wireless device, where the payload is segmented into a set of multiple link layer blocks, each link layer block of the set of multiple link layer blocks including a respective portion of the payload. The acknowledgment component 730 is capable of, configured to, or operable to support a means for receiving, from the second wireless device, one or more negative acknowledgments associated with the set of multiple link layer blocks. The repetition component 735 is capable of, configured to, or operable to support a means for transmitting, to the second wireless device, a quantity of repetitions of at least one link layer block associated with the one or more negative acknowledgments, where the quantity of repetitions is based on a quantity of the one or more negative acknowledgments and a limit of link layer blocks associated with the payload.

In some examples, the capability component 740 is capable of, configured to, or operable to support a means for receiving an indication of a capability of the second wireless device to receive link layer block repetitions, where transmitting the quantity of repetitions is associated with receiving the indication of the capability.

In some examples, the quantity of repetitions is associated with a limitation for a total quantity of repetitions of the at least one link layer block.

In some examples, the quantity of repetitions is associated with a minimum of the limitation for the total quantity of repetitions or a floor value of a ratio of the limit of link layer blocks and the quantity of the one or more negative acknowledgments.

In some examples, to support transmitting the quantity of repetitions, the repetition component 735 is capable of, configured to, or operable to support a means for transmitting a last block of the quantity of repetitions associated with the quantity of repetitions, the quantity of the one or more negative acknowledgments, and the limit of link layer blocks.

In some examples, to support transmitting the last block, the repetition component 735 is capable of, configured to, or operable to support a means for refraining from transmitting a link layer block that would exceed the limit of link layer blocks associated with the payload.

In some examples, the last block is the quantity of repetitions minus one in a condition that the quantity of the one or more negative acknowledgments times the quantity of repetitions is equal to the limit of link layer blocks.

In some examples, transmitting the quantity of repetitions is associated with a first priority of a first link layer block of the set of multiple link layer blocks relative to a second priority of a second link layer block of the set of multiple link layer blocks.

In some examples, a first quantity of repetitions for the first link layer block is greater than a second quantity of repetitions for the second link layer block.

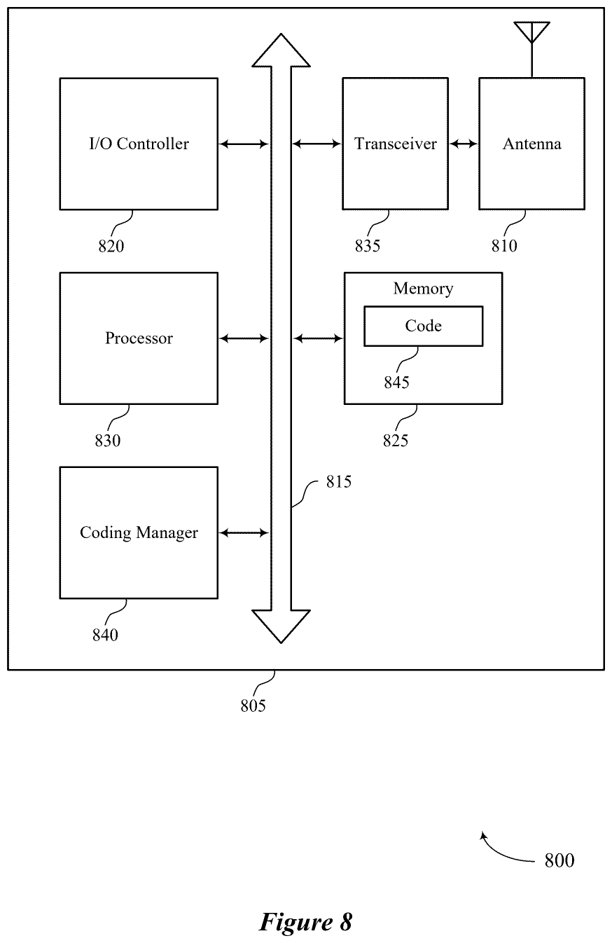

FIG. 8 shows a diagram of a system 800 including a device 805 that supports block retransmission repetitions. The device 805 may be an example of or include components of a device 505, a device 605, or a first wireless device (such as a first wireless device 205 or a first wireless device 205-a) as described herein. The device 805 may include components for bi-directional voice and data communications including components for transmitting and receiving communications, such as an I/O controller, such as an I/O controller 820, one or more antennas 810, at least one memory 825, at least one processor 830, a transceiver 835, a coding manager 840, and code 845. These components may be in electronic communication or otherwise coupled (such as operatively, communicatively, functionally, electronically, electrically) via one or more buses (such as a bus 815).

The memory 825 may include RAM and ROM. The memory 825 may store computer-readable, computer-executable code 845 including instructions that, when executed by the processor 830, cause the device 805 to perform various functions described herein. The code 845 may be stored in a non-transitory computer-readable medium such as system memory or other type of memory. In some examples, the code 845 may not be directly executable by the processor 830 but may cause a computer (such as when compiled and executed) to perform functions described herein. In some examples, the memory 825 may contain, among other things, a BIOS which may control basic hardware or software operation such as the interaction with peripheral components or devices.

The processor 830 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some examples, the processor 830 may be configured to operate a memory array using a memory controller. In some other implementations, a memory controller may be integrated into the processor 830. The processor 830 may be configured to execute computer-readable instructions stored in a memory (such as the memory 825) to cause the device 805 to perform various functions (such as functions or tasks supporting block retransmission repetitions). For example, the device 805 or a component of the device 805 may include a processor 830 and memory 825 coupled with or to the processor 830, the processor 830 and memory 825 configured to perform various functions described herein.

In some examples, the device 805 may include a single antenna. However, in some other implementations the device 805 may have more than one antenna, which may be capable of concurrently transmitting or receiving multiple wireless transmissions. The transceiver 835 may communicate bi-directionally via the one or more antennas 810 using wired or wireless links as described herein. For example, the transceiver 835 may represent a wireless transceiver and may communicate bi-directionally with another wireless transceiver. The transceiver 835 also may include a modem to modulate the packets and provide the modulated packets to one or more antennas 810 for transmission, and to demodulate packets received from the one or more antennas 810. The transceiver 835, or the transceiver 835 and one or more antennas 810, may be an example of a transmitter 515, a transmitter 615, a receiver 510, a receiver 610, or any combination thereof or component thereof, as described herein.

The code 845 may include instructions to implement aspects of the present disclosure, including instructions to support block retransmission repetitions. The code 845 may be stored in a non-transitory computer-readable medium such as system memory or other type of memory. In some examples, the code 845 may not be directly executable by the processor 830 but may cause a computer (such as when compiled and executed) to perform functions described herein.

The I/O controller 820 may support wireless communication in accordance with examples as disclosed herein. For example, the I/O controller 820 is capable of, configured to, or operable to support a means for transmitting a payload to a second wireless device, where the payload is segmented into a set of multiple link layer blocks, each link layer block of the set of multiple link layer blocks including a respective portion of the payload. The I/O controller 820 is capable of, configured to, or operable to support a means for receiving, from the second wireless device, one or more negative acknowledgments associated with the set of multiple link layer blocks. The I/O controller 820 is capable of, configured to, or operable to support a means for transmitting, to the second wireless device, a quantity of repetitions of at least one link layer block associated with the one or more negative acknowledgments, where the quantity of repetitions is associated with a quantity of the one or more negative acknowledgments and a limit of link layer blocks associated with the payload.

By including or configuring the I/O controller 820 in accordance with examples as described herein, the device 805 may support techniques for increased communication reliability, reduced latency, reduced power consumption, more efficient utilization of communication resources, increased coordination between devices, longer battery life, or increased utilization of processing capability.

I/O controller 820 may manage input and output signals for the device 805. I/O controller 820 also may manage peripherals not integrated into the device 805. In some examples, I/O controller 820 may represent a physical connection or port to an external peripheral. In some examples, I/O controller 820 may utilize an operating system such as iOS®, ANDROID®, MS-DOS®, MS-WINDOWS®, OS/2®, UNIX®, LINUX®, or another known operating system. In other examples, I/O controller 820 may represent or interact with a modem, a keyboard, a mouse, a touchscreen, or a similar device. In some examples, I/O controller 820 may be implemented as part of a processor, such as the processor 830. In some examples, a user may interact with the device 805 via I/O controller 820 or via hardware components controlled by I/O controller 820.

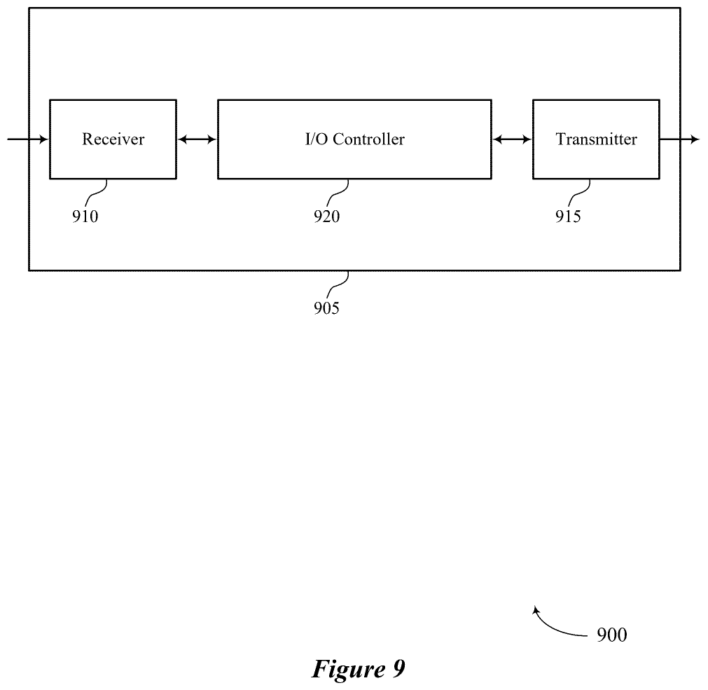

FIG. 9 shows a block diagram 900 of a device 905 that supports block retransmission repetitions. The device 905 may be an example of aspects of a second wireless device (such as a second wireless device 210 or a second wireless device 210-a) as described herein. The device 905 may include a receiver 910, a transmitter 915, and an I/O controller 920. The device 905, or one or more components of the device 905 (such as the receiver 910, the transmitter 915, the I/O controller 920), may include at least one processor, which may be coupled with at least one memory, to, individually or collectively, support or enable the described techniques. Each of these components may be in communication with one another (such as via one or more buses).

The receiver 910 may provide a means for receiving information such as packets, user data, control information, or any combination thereof associated with various information channels (such as control channels, data channels, information channels related to block retransmission repetitions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (such as control channels, data channels, information channels related to block retransmission repetitions). In some examples, the transmitter 915 may be co-located with a receiver 910 in a transceiver module. The transmitter 915 may utilize a single antenna or a set of multiple antennas.

The I/O controller 920, the receiver 910, the transmitter 915, or various combinations or components thereof may be examples of means for performing various aspects of block retransmission repetitions as described herein. For example, the I/O controller 920, the receiver 910, the transmitter 915, or various combinations or components thereof may be capable of performing one or more of the functions described herein.

In some examples, the I/O controller 920, the receiver 910, the transmitter 915, or various combinations or components thereof may be implemented in hardware (such as in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (such as by one or more processors, individually or collectively, executing instructions stored in the at least one memory).

Additionally, or alternatively, the I/O controller 920, the receiver 910, the transmitter 915, or various combinations or components thereof may be implemented in code (such as communications management software or firmware) executed by at least one processor (such as referred to as a processor-executable code). If implemented in code executed by at least one processor, the functions of the I/O controller 920, the receiver 910, the transmitter 915, or various combinations or components thereof may be performed by a general-purpose processor, a DSP, a CPU, an ASIC, an FPGA, a microcontroller, or any combination of these or other programmable logic devices (such as configured as or otherwise supporting, individually or collectively, a means for performing the functions described in the present disclosure).

In some examples, the I/O controller 920 may be configured to perform various operations (such as receiving, obtaining, monitoring, outputting, transmitting) using or otherwise in cooperation with the receiver 910, the transmitter 915, or both. For example, the I/O controller 920 may receive information from the receiver 910, send information to the transmitter 915, or be integrated in combination with the receiver 910, the transmitter 915, or both to obtain information, output information, or perform various other operations as described herein.

The I/O controller 920 may support wireless communication in accordance with examples as disclosed herein. For example, the I/O controller 920 is capable of, configured to, or operable to support a means for receiving a payload from a first wireless device, where the payload is segmented into a set of multiple link layer blocks, each link layer block of the set of multiple link layer blocks including a respective portion of the payload. The I/O controller 920 is capable of, configured to, or operable to support a means for transmitting, to the first wireless device, one or more negative acknowledgments associated with the set of multiple link layer blocks. The I/O controller 920 is capable of, configured to, or operable to support a means for receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload.

By including or configuring the I/O controller 920 in accordance with examples as described herein, the device 905 (such as at least one processor controlling or otherwise coupled with the receiver 910, the transmitter 915, the I/O controller 920, or a combination thereof) may support techniques for reduced processing, reduced power consumption, or more efficient utilization of communication resources.

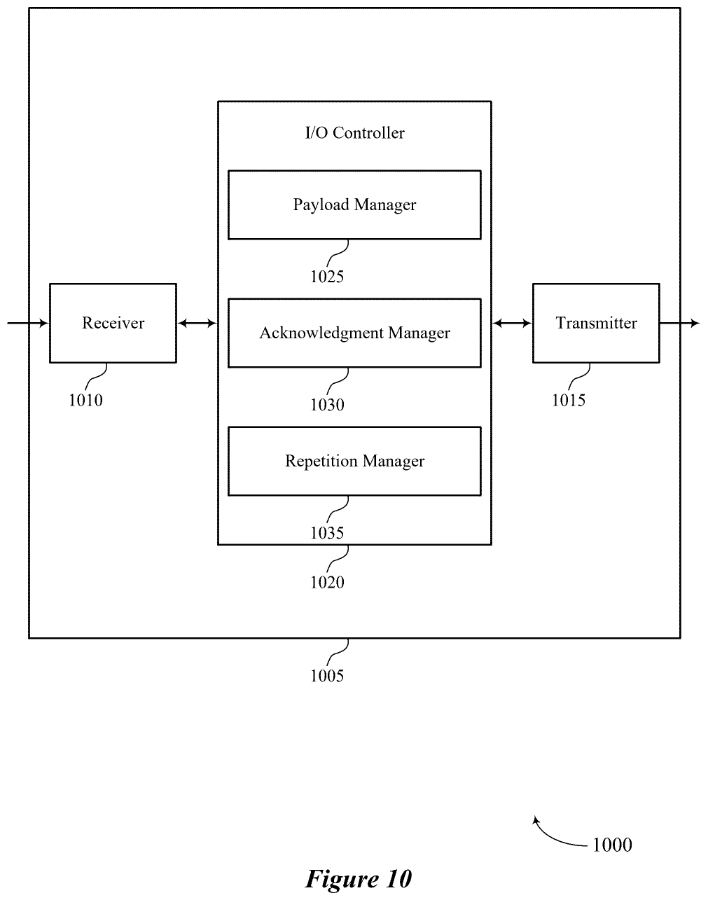

FIG. 10 shows a block diagram 1000 of a device 1005 that supports block retransmission repetitions. The device 1005 may be an example of aspects of a device 905 or a second wireless device (such as a second wireless device 210 or a second wireless device 210-a) as described herein. The device 1005 may include a receiver 1010, a transmitter 1015, and an I/O controller 1020. The device 1005, or one or more components of the device 1005 (such as the receiver 1010, the transmitter 1015, the I/O controller 1020), may include at least one processor, which may be coupled with at least one memory, to support the described techniques. Each of these components may be in communication with one another (such as via one or more buses).

The receiver 1010 may provide a means for receiving information such as packets, user data, control information, or any combination thereof associated with various information channels (such as control channels, data channels, information channels related to block retransmission repetitions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (such as control channels, data channels, information channels related to block retransmission repetitions). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of block retransmission repetitions as described herein. For example, the I/O controller 1020 may include a payload manager 1025, an acknowledgment manager 1030, a repetition manager 1035, or any combination thereof. The I/O controller 1020 may be an example of aspects of a I/O controller 920 as described herein. In some examples, the I/O controller 1020, or various components thereof, may be configured to perform various operations (such as receiving, obtaining, monitoring, outputting, transmitting) using or otherwise in cooperation with the receiver 1010, the transmitter 1015, or both. For example, the I/O controller 1020 may receive information from the receiver 1010, send information to the transmitter 1015, or be integrated in combination with the receiver 1010, the transmitter 1015, or both to obtain information, output information, or perform various other operations as described herein.

The I/O controller 1020 may support wireless communication in accordance with examples as disclosed herein. The payload manager 1025 is capable of, configured to, or operable to support a means for receiving a payload from a first wireless device, where the payload is segmented into a set of multiple link layer blocks, each link layer block of the set of multiple link layer blocks including a respective portion of the payload. The acknowledgment manager 1030 is capable of, configured to, or operable to support a means for transmitting, to the first wireless device, one or more negative acknowledgments associated with the set of multiple link layer blocks. The repetition manager 1035 is capable of, configured to, or operable to support a means for receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload.

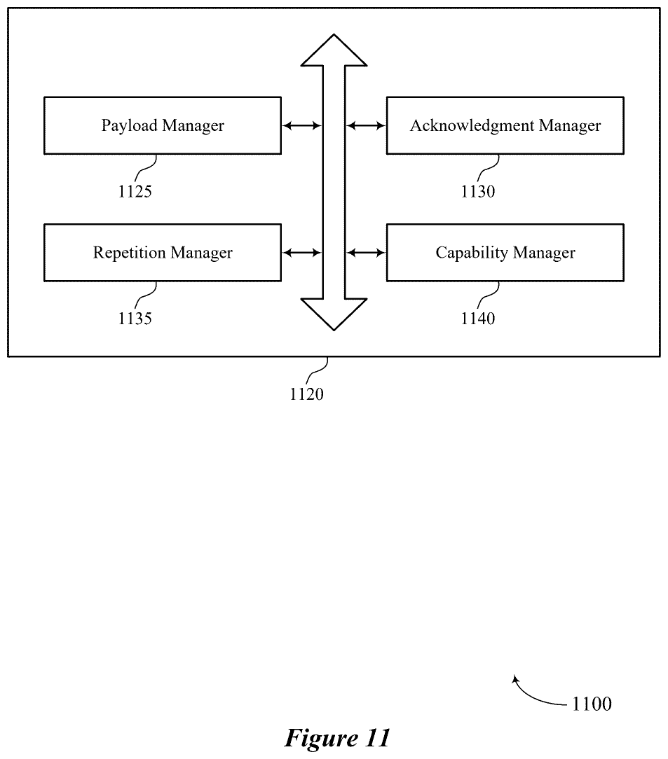

FIG. 11 shows a block diagram 1100 of an I/O controller 1120 that supports block retransmission repetitions. The I/O controller 1120 may be an example of aspects of an I/O controller 920, an I/O controller 1020, or both, as described herein. The I/O controller 1120, or various components thereof, may be an example of means for performing various aspects of block retransmission repetitions as described herein. For example, the I/O controller 1120 may include a payload manager 1125, an acknowledgment manager 1130, a repetition manager 1135, a capability manager 1140, or any combination thereof. Each of these components, or components or subcomponents thereof (such as one or more processors, one or more memories), may communicate, directly or indirectly, with one another (such as via one or more buses).

The I/O controller 1120 may support wireless communication in accordance with examples as disclosed herein. The payload manager 1125 is capable of, configured to, or operable to support a means for receiving a payload from a first wireless device, where the payload is segmented into a set of multiple link layer blocks, each link layer block of the set of multiple link layer blocks including a respective portion of the payload. The acknowledgment manager 1130 is capable of, configured to, or operable to support a means for transmitting, to the first wireless device, one or more negative acknowledgments associated with the set of multiple link layer blocks. The repetition manager 1135 is capable of, configured to, or operable to support a means for receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload.

In some examples, the capability manager 1140 is capable of, configured to, or operable to support a means for transmitting an indication of a capability of the second wireless device to receive link layer block repetitions, where receiving the quantity of repetitions is associated with transmitting the indication of the capability.

In some examples, the quantity of repetitions is associated with a limitation for a total quantity of repetitions of the at least one link layer block.

In some examples, the quantity of repetitions is associated with a minimum of the limitation for the total quantity of repetitions or a floor value of a ratio of the limit of link layer blocks and the quantity of the one or more negative acknowledgments.

In some examples, to support receiving the quantity of repetitions, the repetition manager 1135 is capable of, configured to, or operable to support a means for receiving a last block of the quantity of repetitions associated with the quantity of repetitions, the quantity of the one or more negative acknowledgments, and the limit of link layer blocks.

In some examples, to support receiving the last block, the repetition manager 1135 is capable of, configured to, or operable to support a means for refraining from receiving a link layer block that would exceed the limit of link layer blocks associated with the payload.

In some examples, the last block is the quantity of repetitions minus one in a condition that the quantity of the one or more negative acknowledgments times the quantity of repetitions is equal to the limit of link layer blocks.

In some examples, receiving the quantity of repetitions is associated with a first priority of a first link layer block of the set of multiple link layer blocks relative to a second priority of a second link layer block of the set of multiple link layer blocks.

In some examples, a first quantity of repetitions for the first link layer block is greater than a second quantity of repetitions for the second link layer block.

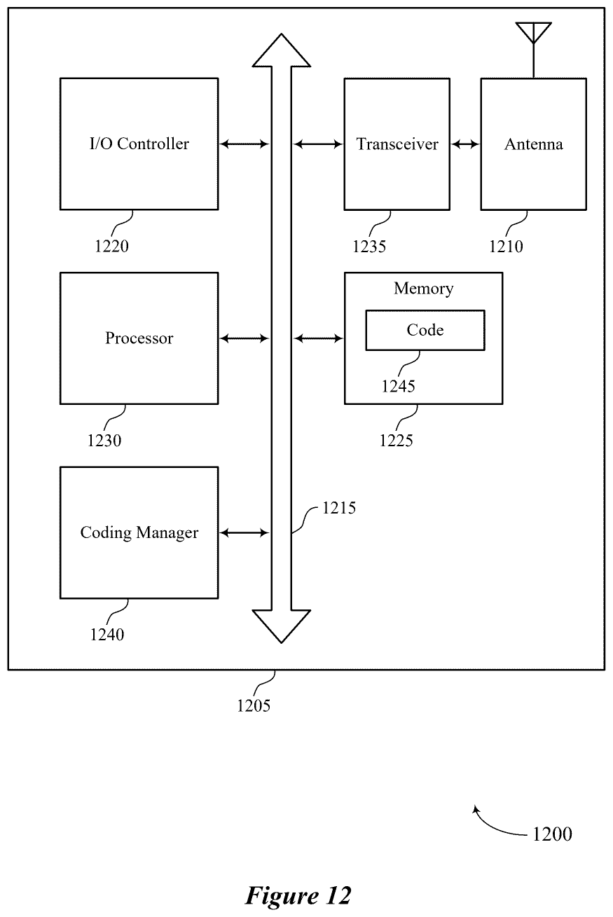

FIG. 12 shows a diagram of a system 1200 including a device 1205 that supports block retransmission repetitions. The device 1205 may be an example of or include components of a device 905, a device 1005, or a second wireless device (such as a second wireless device 210 or a second wireless device 210-a) as described herein. The device 1205 may include components for bi-directional voice and data communications including components for transmitting and receiving communications, such as an I/O controller, such as an I/O controller 1220, one or more antennas 1210, at least one memory 1225, at least one processor 1230, a transceiver 1235, a coding manager 1240, and code 1245. These components may be in electronic communication or otherwise coupled (such as operatively, communicatively, functionally, electronically, electrically) via one or more buses (such as a bus 1215).

The memory 1225 may include RAM and ROM. The memory 1225 may store computer-readable, computer-executable code 1245 including instructions that, when executed by the processor 1230, cause the device 1205 to perform various functions described herein. The code 1245 may be stored in a non-transitory computer-readable medium such as system memory or other type of memory. In some examples, the code 1245 may not be directly executable by the processor 1230 but may cause a computer (such as when compiled and executed) to perform functions described herein. In some examples, the memory 1225 may contain, among other things, a BIOS which may control basic hardware or software operation such as the interaction with peripheral components or devices.

The processor 1230 may include an intelligent hardware device, (such as a general-purpose processor, a DSP, a CPU, a microcontroller, an ASIC, an FPGA, a programmable logic device, a discrete gate or transistor logic component, a discrete hardware component, or any combination thereof). In some examples, the processor 1230 may be configured to operate a memory array using a memory controller. In some other examples, a memory controller may be integrated into the processor 1230. The processor 1230 may be configured to execute computer-readable instructions stored in a memory (such as the memory 1225) to cause the device 1205 to perform various functions (such as functions or tasks supporting block retransmission repetitions). For example, the device 1205 or a component of the device 1205 may include a processor 1230 and memory 1225 coupled with or to the processor 1230, the processor 1230 and memory 1225 configured to perform various functions described herein.

In some examples, the device 1205 may include a single antenna. However, in some other examples the device 1205 may have more than one antenna, which may be capable of concurrently transmitting or receiving multiple wireless transmissions. The transceiver 1235 may communicate bi-directionally via the one or more antennas 1210 using wired or wireless links as described herein. For example, the transceiver 1235 may represent a wireless transceiver and may communicate bi-directionally with another wireless transceiver. The transceiver 1235 also may include a modem to modulate the packets and provide the modulated packets to one or more antennas 1210 for transmission, and to demodulate packets received from the one or more antennas 1210. The transceiver 1235, or the transceiver 1235 and one or more antennas 1210, may be an example of a transmitter 915, a transmitter 1015, a receiver 910, a receiver 1010, or any combination thereof or component thereof, as described herein.

The code 1245 may include instructions to implement aspects of the present disclosure, including instructions to support block retransmission repetitions. The code 1245 may be stored in a non-transitory computer-readable medium such as system memory or other type of memory. In some examples, the code 1245 may not be directly executable by the processor 1230 but may cause a computer (such as when compiled and executed) to perform functions described herein.

The I/O controller 1220 may support wireless communication in accordance with examples as disclosed herein. For example, the I/O controller 1220 is capable of, configured to, or operable to support a means for receiving a payload from a first wireless device, where the payload is segmented into a set of multiple link layer blocks, each link layer block of the set of multiple link layer blocks including a respective portion of the payload. The I/O controller 1220 is capable of, configured to, or operable to support a means for transmitting, to the first wireless device, one or more negative acknowledgments associated with the set of multiple link layer blocks. The I/O controller 1220 is capable of, configured to, or operable to support a means for receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload.

By including or configuring the I/O controller 1220 in accordance with examples as described herein, the device 1205 may support techniques for increased communication reliability, reduced latency, reduced power consumption, more efficient utilization of communication resources, increased coordination between devices, longer battery life, or increased utilization of processing capability.

The I/O controller 1220 may manage input and output signals for the device 1205. The I/O controller 1220 also may manage peripherals not integrated into the device 1205. In some examples, The I/O controller 1220 may represent a physical connection or port to an external peripheral. In some examples, The I/O controller 1220 may utilize an operating system such as iOS®, ANDROID®, MS-DOS®, MS-WINDOWS®, OS/2®, UNIX®, LINUX®, or another known operating system. In other examples, The I/O controller 1220 may represent or interact with a modem, a keyboard, a mouse, a touchscreen, or a similar device. In some examples, The I/O controller 1220 may be implemented as part of a processor, such as the processor 1230. In some examples, a user may interact with the device 1205 via The I/O controller 1220 or via hardware components controlled by The I/O controller 1220.

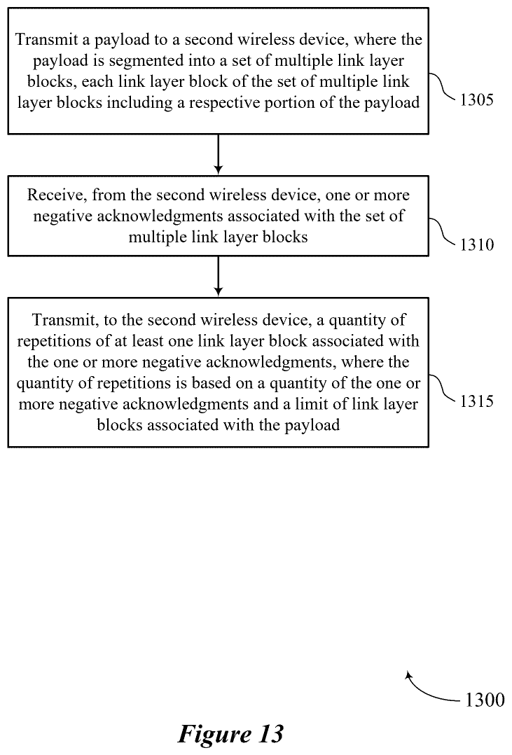

FIG. 13 shows a flowchart illustrating a method 1300 that supports block retransmission repetitions. The operations of the method 1300 may be implemented by a first wireless device (such as a first wireless device 205 or a first wireless device 205-a) or its components as described herein. For example, the operations of the method 1300 may be performed by a first wireless device as described with reference to FIGS. 1 through 8. In some examples, a first wireless device may execute a set of instructions to control the functional elements of the first wireless device to perform the described functions. Additionally, or alternatively, the first wireless device may perform aspects of the described functions using special-purpose hardware.

At 1305, the method may include transmitting a payload to a second wireless device, where the payload is segmented into a set of multiple link layer blocks, each link layer block of the set of multiple link layer blocks including a respective portion of the payload. The operations of 1305 may be performed in accordance with examples as disclosed herein. In some examples, aspects of the operations of 1305 may be performed by a payload component 725 as described with reference to FIG. 7.

At 1310, the method may include receiving, from the second wireless device, one or more negative acknowledgments associated with the set of multiple link layer blocks. The operations of 1310 may be performed in accordance with examples as disclosed herein. In some examples, aspects of the operations of 1310 may be performed by an acknowledgment component 730 as described with reference to FIG. 7.

At 1315, the method may include transmitting, to the second wireless device, a quantity of repetitions of at least one link layer block associated with the one or more negative acknowledgments, where the quantity of repetitions is associated with a quantity of the one or more negative acknowledgments and a limit of link layer blocks associated with the payload. The operations of 1315 may be performed in accordance with examples as disclosed herein. In some examples, aspects of the operations of 1315 may be performed by a repetition component 735 as described with reference to FIG. 7.

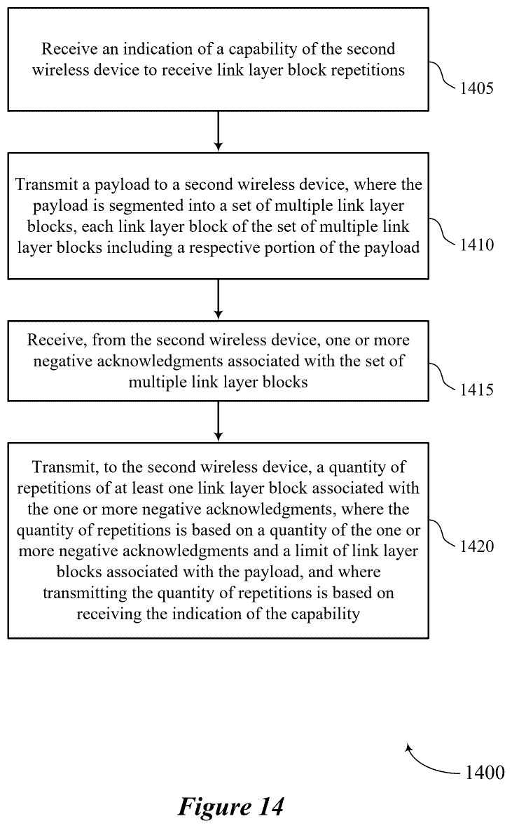

FIG. 14 shows a flowchart illustrating a method 1400 that supports block retransmission repetitions. The operations of the method 1400 may be implemented by a first wireless device (such as a first wireless device 205 or a first wireless device 205-a) or its components as described herein. For example, the operations of the method 1400 may be performed by a first wireless device as described with reference to FIGS. 1 through 8. In some examples, a first wireless device may execute a set of instructions to control the functional elements of the first wireless device to perform the described functions. Additionally, or alternatively, the first wireless device may perform aspects of the described functions using special-purpose hardware.

At 1405, the method may include receiving an indication of a capability of the second wireless device to receive link layer block repetitions. The operations of 1405 may be performed in accordance with examples as disclosed herein. In some examples, aspects of the operations of 1405 may be performed by a capability component 740 as described with reference to FIG. 7.

At 1410, the method may include transmitting a payload to a second wireless device, where the payload is segmented into a set of multiple link layer blocks, each link layer block of the set of multiple link layer blocks including a respective portion of the payload. The operations of 1410 may be performed in accordance with examples as disclosed herein. In some examples, aspects of the operations of 1410 may be performed by a payload component 725 as described with reference to FIG. 7.

At 1415, the method may include receiving, from the second wireless device, one or more negative acknowledgments associated with the set of multiple link layer blocks. The operations of 1415 may be performed in accordance with examples as disclosed herein. In some examples, aspects of the operations of 1415 may be performed by an acknowledgment component 730 as described with reference to FIG. 7.

At 1420, the method may include transmitting, to the second wireless device, a quantity of repetitions of at least one link layer block associated with the one or more negative acknowledgments, where the quantity of repetitions is associated with a quantity of the one or more negative acknowledgments and a limit of link layer blocks associated with the payload, and where transmitting the quantity of repetitions is associated with receiving the indication of the capability. The operations of 1420 may be performed in accordance with examples as disclosed herein. In some examples, aspects of the operations of 1420 may be performed by a repetition component 735 as described with reference to FIG. 7.

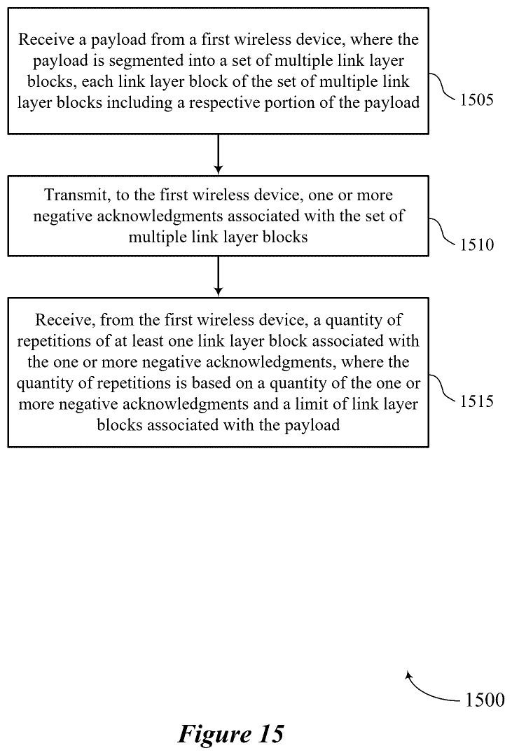

FIG. 15 shows a flowchart illustrating a method 1500 that supports block retransmission repetitions. The operations of the method 1500 may be implemented by a second wireless device (such as a second wireless device 210 or a second wireless device 210-a) or its components as described herein. For example, the operations of the method 1500 may be performed by a second wireless device as described with reference to FIGS. 1 through 4 and 9 through 12. In some examples, a second wireless device may execute a set of instructions to control the functional elements of the second wireless device to perform the described functions. Additionally, or alternatively, the second wireless device may perform aspects of the described functions using special-purpose hardware.

At 1505, the method may include receiving a payload from a first wireless device, where the payload is segmented into a set of multiple link layer blocks, each link layer block of the set of multiple link layer blocks including a respective portion of the payload. The operations of 1505 may be performed in accordance with examples as disclosed herein. In some examples, aspects of the operations of 1505 may be performed by a payload manager 1125 as described with reference to FIG. 11.

At 1510, the method may include transmitting, to the first wireless device, one or more negative acknowledgments associated with the set of multiple link layer blocks. The operations of 1510 may be performed in accordance with examples as disclosed herein. In some examples, aspects of the operations of 1510 may be performed by an acknowledgment manager 1130 as described with reference to FIG. 11.

At 1515, the method may include receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload. The operations of 1515 may be performed in accordance with examples as disclosed herein. In some examples, aspects of the operations of 1515 may be performed by a repetition manager 1135 as described with reference to FIG. 11.

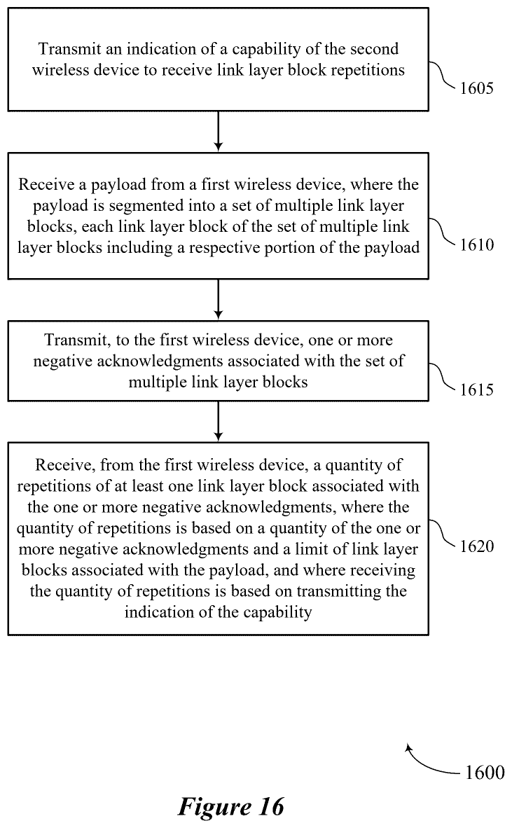

FIG. 16 shows a flowchart illustrating a method 1600 that supports block retransmission repetitions. The operations of the method 1600 may be implemented by a second wireless device (such as a second wireless device 210 or a second wireless device 210-a) or its components as described herein. For example, the operations of the method 1600 may be performed by a second wireless device as described with reference to FIGS. 1 through 4 and 9 through 12. In some examples, a second wireless device may execute a set of instructions to control the functional elements of the second wireless device to perform the described functions. Additionally, or alternatively, the second wireless device may perform aspects of the described functions using special-purpose hardware.

At 1605, the method may include transmitting an indication of a capability of the second wireless device to receive link layer block repetitions. The operations of 1605 may be performed in accordance with examples as disclosed herein. In some examples, aspects of the operations of 1605 may be performed by a capability manager 1140 as described with reference to FIG. 11.

At 1610, the method may include receiving a payload from a first wireless device, where the payload is segmented into a set of multiple link layer blocks, each link layer block of the set of multiple link layer blocks including a respective portion of the payload. The operations of 1610 may be performed in accordance with examples as disclosed herein. In some examples, aspects of the operations of 1610 may be performed by a payload manager 1125 as described with reference to FIG. 11.

At 1615, the method may include transmitting, to the first wireless device, one or more negative acknowledgments associated with the set of multiple link layer blocks. The operations of 1615 may be performed in accordance with examples as disclosed herein. In some examples, aspects of the operations of 1615 may be performed by an acknowledgment manager 1130 as described with reference to FIG. 11.

At 1620, the method may include receiving, from the first wireless device, a quantity of repetitions of at least one link layer block associated with the one or more negative acknowledgments, where the quantity of repetitions is associated with a quantity of the one or more negative acknowledgments and a limit of link layer blocks associated with the payload, and where receiving the quantity of repetitions is associated with transmitting the indication of the capability. The operations of 1620 may be performed in accordance with examples as disclosed herein. In some examples, aspects of the operations of 1620 may be performed by a repetition manager 1135 as described with reference to FIG. 11.

Implementation examples are described in the following numbered clauses:

Aspect 1: A method for wireless communication at a first wireless device, including: transmitting a payload to a second wireless device, where the payload is segmented into a plurality of link layer blocks, each link layer block of the plurality of link layer blocks including a respective portion of the payload; receiving, from the second wireless device, one or more negative acknowledgments associated with the plurality of link layer blocks; and transmitting, to the second wireless device, a quantity of repetitions of at least one link layer block associated with the one or more negative acknowledgments, where the quantity of repetitions is based at least in part on a quantity of the one or more negative acknowledgments and a limit of link layer blocks associated with the payload.

Aspect 2: The method of aspect 1, further including: receiving an indication of a capability of the second wireless device to receive link layer block repetitions, where transmitting the quantity of repetitions is based at least in part on receiving the indication of the capability.

Aspect 3: The method of any of aspects 1 through 2, where the quantity of repetitions is based at least in part on a limitation for a total quantity of repetitions of the at least one link layer block.

Aspect 4: The method of aspect 3, where the quantity of repetitions is based at least in part on a minimum of the limitation for the total quantity of repetitions or a floor value of a ratio of the limit of link layer blocks and the quantity of the one or more negative acknowledgments.

Aspect 5: The method of any of aspects 3 through 4, where transmitting the quantity of repetitions includes: transmitting a last block of the quantity of repetitions based at least in part on the quantity of repetitions, the quantity of the one or more negative acknowledgments, and the limit of link layer blocks.

Aspect 6: The method of aspect 5, where transmitting the last block includes: refraining from transmitting a link layer block that would exceed the limit of link layer blocks associated with the payload.

Aspect 7: The method of any of aspects 5 through 6, where the last block is the quantity of repetitions minus one in a case that the quantity of the one or more negative acknowledgments times the quantity of repetitions is equal to the limit of link layer blocks.

Aspect 8: The method of any of aspects 1 through 7, where transmitting the quantity of repetitions is based on a first priority of a first link layer block of the plurality of link layer blocks relative to a second priority of a second link layer block of the plurality of link layer blocks.

Aspect 9: The method of aspect 8, where a first quantity of repetitions for the first link layer block is greater than a second quantity of repetitions for the second link layer block.

Aspect 10: A method for wireless communication at a second wireless device, including: receiving a payload from a first wireless device, where the payload is segmented into a plurality of link layer blocks, each link layer block of the plurality of link layer blocks including a respective portion of the payload; transmitting, to the first wireless device, one or more negative acknowledgments associated with the plurality of link layer blocks; and receiving, from the first wireless device, a quantity of repetitions of at least one link layer block associated with the one or more negative acknowledgments, where the quantity of repetitions is based at least in part on a quantity of the one or more negative acknowledgments and a limit of link layer blocks associated with the payload.

Aspect 11: The method of aspect 10, further including: transmitting an indication of a capability of the second wireless device to receive link layer block repetitions, where receiving the quantity of repetitions is based at least in part on transmitting the indication of the capability.

Aspect 12: The method of any of aspects 10 through 11, where the quantity of repetitions is based at least in part on a limitation for a total quantity of repetitions of the at least one link layer block.

Aspect 13: The method of aspect 12, where the quantity of repetitions is based at least in part on a minimum of the limitation for the total quantity of repetitions or a floor value of a ratio of the limit of link layer blocks and the quantity of the one or more negative acknowledgments.

Aspect 14: The method of any of aspects 12 through 13, where receiving the quantity of repetitions includes: receiving a last block of the quantity of repetitions based at least in part on the quantity of repetitions, the quantity of the one or more negative acknowledgments, and the limit of link layer blocks.

Aspect 15: The method of aspect 14, where receiving the last block includes: refraining from receiving a link layer block that would exceed the limit of link layer blocks associated with the payload.

Aspect 16: The method of any of aspects 14 through 15, where the last block is the quantity of repetitions minus one in a case that the quantity of the one or more negative acknowledgments times the quantity of repetitions is equal to the limit of link layer blocks.

Aspect 17: The method of any of aspects 10 through 16, where receiving the quantity of repetitions is based on a first priority of a first link layer block of the plurality of link layer blocks relative to a second priority of a second link layer block of the plurality of link layer blocks.

Aspect 18: The method of aspect 17, where a first quantity of repetitions for the first link layer block is greater than a second quantity of repetitions for the second link layer block.

Aspect 19: A first wireless device for wireless communication, including one or more memories storing processor-executable code, and one or more processors coupled with the one or more memories and individually or collectively operable to execute the code to cause the first wireless device to perform a method of any of aspects 1 through 9.

Aspect 20: A first wireless device for wireless communication, including at least one means for performing a method of any of aspects 1 through 9.

Aspect 21: A non-transitory computer-readable medium storing code for wireless communication, the code including instructions executable by one or more processors to perform a method of any of aspects 1 through 9.

Aspect 22: A second wireless device for wireless communication, including one or more memories storing processor-executable code, and one or more processors coupled with the one or more memories and individually or collectively operable to execute the code to cause the second wireless device to perform a method of any of aspects 10 through 18.

Aspect 23: A second wireless device for wireless communication, including at least one means for performing a method of any of aspects 10 through 18.

Aspect 24: A non-transitory computer-readable medium storing code for wireless communication, the code including instructions executable by one or more processors to perform a method of any of aspects 10 through 18.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit a payload to a second wireless device, wherein the payload is segmented into a plurality of link layer blocks, each link layer block of the plurality of link layer blocks comprising a respective portion of the payload;
receive, from the second wireless device, one or more negative acknowledgments associated with the plurality of link layer blocks; and
transmit, to the second wireless device, a quantity of repetitions of at least one link layer block associated with the one or more negative acknowledgments, wherein the quantity of repetitions is associated with a quantity of the one or more negative acknowledgments and a limit of link layer blocks associated with the payload.

2. The first wireless device of claim 1, wherein the processing system is further configured to cause the first wireless device to:
receive an indication of a capability of the second wireless device to receive link layer block repetitions, wherein transmitting the quantity of repetitions is associated with receiving the indication of the capability.

3. The first wireless device of claim 1, wherein the quantity of repetitions is associated with a limitation for a total quantity of repetitions of the at least one link layer block.

4. The first wireless device of claim 3, wherein the quantity of repetitions is associated with a minimum of the limitation for the total quantity of repetitions or a floor value of a ratio of the limit of link layer blocks and the quantity of the one or more negative acknowledgments.

5. The first wireless device of claim 3, wherein, to transmit the quantity of repetitions, the processing system is configured to cause the first wireless device to:
transmit a last block of the quantity of repetitions in accordance with the quantity of repetitions, the quantity of the one or more negative acknowledgments, and the limit of link layer blocks.

6. The first wireless device of claim 5, wherein, to transmit the last block, the processing system is configured to cause the first wireless device to:
refrain from transmitting a link layer block that would exceed the limit of link layer blocks associated with the payload.

7. The first wireless device of claim 5, wherein the last block is the quantity of repetitions minus one in a condition that the quantity of the one or more negative acknowledgments times the quantity of repetitions is equal to the limit of link layer blocks.

8. The first wireless device of claim 1, wherein transmitting the quantity of repetitions is associated with a first priority of a first link layer block of the plurality of link layer blocks relative to a second priority of a second link layer block of the plurality of link layer blocks.

9. The first wireless device of claim 8, wherein a first quantity of repetitions for the first link layer block is greater than a second quantity of repetitions for the second link layer block based at least in part on the first priority being higher than the second priority.

10. A second wireless device, comprising:
a processing system that includes processor circuitry and memory circuitry that stores code, the processing system configured to cause the second wireless device to:
receive a payload from a first wireless device, wherein the payload is segmented into a plurality of link layer blocks, each link layer block of the plurality of link layer blocks comprising a respective portion of the payload;
transmit, to the first wireless device, one or more negative acknowledgments associated with the plurality of link layer blocks; and
receive, from the first wireless device, a quantity of repetitions of at least one link layer block associated with the one or more negative acknowledgments, wherein the quantity of repetitions is associated with a quantity of the one or more negative acknowledgments and a limit of link layer blocks associated with the payload.

11. The second wireless device of claim 10, wherein the processing system is further configured to cause the second wireless device to:
transmit an indication of a capability of the second wireless device to receive link layer block repetitions, wherein receiving the quantity of repetitions is associated with transmitting the indication of the capability.

12. The second wireless device of claim 10, wherein the quantity of repetitions is associated with a limitation for a total quantity of repetitions of the at least one link layer block.

13. The second wireless device of claim 12, wherein the quantity of repetitions is associated with a minimum of the limitation for the total quantity of repetitions or a floor value of a ratio of the limit of link layer blocks and the quantity of the one or more negative acknowledgments.

14. The second wireless device of claim 12, wherein, to receive the quantity of repetitions, the processing system is configured to cause the second wireless device to:
receive a last block of the quantity of repetitions in accordance with the quantity of repetitions, the quantity of the one or more negative acknowledgments, and the limit of link layer blocks.

15. The second wireless device of claim 14, wherein, to receive the last block, the processing system is configured to cause the second wireless device to:
refrain from receiving a link layer block that would exceed the limit of link layer blocks associated with the payload.

16. The second wireless device of claim 14, wherein the last block is the quantity of repetitions minus one in a condition that the quantity of the one or more negative acknowledgments times the quantity of repetitions is equal to the limit of link layer blocks.

17. The second wireless device of claim 10, wherein receiving the quantity of repetitions is associated with a first priority of a first link layer block of the plurality of link layer blocks relative to a second priority of a second link layer block of the plurality of link layer blocks.

18. The second wireless device of claim 17, wherein a first quantity of repetitions for the first link layer block is greater than a second quantity of repetitions for the second link layer block, based at least in part on the first priority being higher than the second priority.

19. A method for wireless communication at a first wireless device, comprising:
transmitting a payload to a second wireless device, wherein the payload is segmented into a plurality of link layer blocks, each link layer block of the plurality of link layer blocks comprising a respective portion of the payload;
receiving, from the second wireless device, one or more negative acknowledgments associated with the plurality of link layer blocks; and
transmitting, to the second wireless device, a quantity of repetitions of at least one link layer block associated with the one or more negative acknowledgments, wherein the quantity of repetitions is associated with a quantity of the one or more negative acknowledgments and a limit of link layer blocks associated with the payload.

20. The method of claim 19, further comprising:
receiving an indication of a capability of the second wireless device to receive link layer block repetitions, wherein transmitting the quantity of repetitions is associated with receiving the indication of the capability.

21. The method of claim 19, wherein the quantity of repetitions is associated with a limitation for a total quantity of repetitions of the at least one link layer block.

22. The method of claim 21, wherein the quantity of repetitions is associated with a minimum of the limitation for the total quantity of repetitions or a floor value of a ratio of the limit of link layer blocks and the quantity of the one or more negative acknowledgments.

23. The method of claim 21, wherein transmitting the quantity of repetitions comprises:
transmitting a last block of the quantity of repetitions in accordance with the quantity of repetitions, the quantity of the one or more negative acknowledgments, and the limit of link layer blocks.

24. The method of claim 23, wherein transmitting the last block comprises:
refraining from transmitting a link layer block that would exceed the limit of link layer blocks associated with the payload.

25. A method for wireless communication at a second wireless device, comprising:
receiving a payload from a first wireless device, wherein the payload is segmented into a plurality of link layer blocks, each link layer block of the plurality of link layer blocks comprising a respective portion of the payload;
transmitting, to the first wireless device, one or more negative acknowledgments associated with the plurality of link layer blocks; and
receiving, from the first wireless device, a quantity of repetitions of at least one link layer block associated with the one or more negative acknowledgments, wherein the quantity of repetitions is associated with a quantity of the one or more negative acknowledgments and a limit of link layer blocks associated with the payload.

26. The method of claim 25, further comprising:
transmitting an indication of a capability of the second wireless device to receive link layer block repetitions, wherein receiving the quantity of repetitions is associated with transmitting the indication of the capability.

27. The method of claim 25, wherein the quantity of repetitions is associated with a limitation for a total quantity of repetitions of the at least one link layer block.

28. The method of claim 27, wherein the quantity of repetitions is associated with a minimum of the limitation for the total quantity of repetitions or a floor value of a ratio of the limit of link layer blocks and the quantity of the one or more negative acknowledgments.

29. The method of claim 27, wherein receiving the quantity of repetitions comprises:
receiving a last block of the quantity of repetitions in accordance with the quantity of repetitions, the quantity of the one or more negative acknowledgments, and the limit of link layer blocks.

30. The method of claim 29, wherein receiving the last block comprises:
refraining from receiving a link layer block that would exceed the limit of link layer blocks associated with the payload.
